(19) United States
(12) Patent Application Publication
(10) Pub. No.: US 2024/0396914 A1
(43) Pub. Date: Nov. 28, 2024

(54) SYSTEMS AND METHODS FOR NETWORK TRAFFIC FINGERPRINTING AND ASSOCIATED SECURITY ACTIONS

(71) Applicant: FoxIO, LLC, Austin, TX (US)

(72) Inventor: John Brooke Althouse, Round Hill, VA (US)

(21) Appl. No.: 18/676,422

(22) Filed: May 28, 2024

Related U.S. Application Data
(60) Provisional application No. 63/468,970, filed on May 25, 2023.
(60) Provisional application No. 63/525,950, filed on Jul. 10, 2023.
(60) Provisional application No. 63/535,273, filed on Aug. 29, 2023.
(60) Provisional application No. 63/620,123, filed on Jan. 11, 2024.
(60) Provisional application No. 63/648,478, filed on May 16, 2024.
(60) Provisional application No. 63/608,798, filed on Dec. 11, 2023.

(51) Int. Cl. H04L 9/40

(52) U.S. Cl. CPC H04L 63/1425; H04L 63/166

(57) ABSTRACT

Systems and methods for network traffic fingerprinting and associated security actions. Data related to communications over a network are received. Information is then extracted from said data and organized into one or more component fingerprints, which can be combined into a composite fingerprint. Each component fingerprint is organized into a delimited text string with a plurality of discrete sections, with most component fingerprints including at least one human-readable section. The component fingerprints are then output to a user or another system for analysis.

### BACKGROUND OF THE DISCLOSURE

This application claims the priority benefit of U.S. Provisional Patent Application No. 63/468,970, filed on May 25, 2023 and entitled “Systems and Methods for Passive Network Traffic Fingerprinting,” the priority benefit of U.S. Provisional Patent Application No. 63/525,950, filed on Jul. 10, 2023 and entitled “Systems and Methods for Passive Network Traffic Fingerprinting Including Wireless Devices”, the priority of benefit of U.S. Provisional Patent Application No. 63/535,273, filed Aug. 29, 2023 and entitled “Systems and Methods for Passive Network Traffic Fingerprinting including Wireless Devices”, the priority benefit of U.S. Provisional Patent Application No. 63/608,798, filed Dec. 11, 2023 and entitled “Systems and Methods for Passive Network Traffic Fingerprinting Including Virtual Private Network and Proxy Detection and Location”, the priority benefit of U.S. Provisional Patent Application No. 63/620,123, filed Jan. 11, 2024 and entitled Systems and Methods for Passive Network Traffic Fingerprinting Including Virtual Private Network and Proxy Detection and Location”, and the priority benefit of U.S. Provisional Application No. 63/648,478 filed May 16, 2024 and entitled “Systems and Methods for Blocking Internet Scanners Using Network Traffic Fingerprints.”

### FIELD

This application is directed generally to systems and methods for creating and analyzing network traffic fingerprints and securing network systems using the same.

### DESCRIPTION OF THE RELATED ART

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In some systems, client and server applications may use the transport layer security (TLS) protocol to provide security for communications over the Internet. The TLS protocol may include a number of sub-protocols to allow the client and server applications to determine security parameters, authenticate each other, instantiate negotiated security parameters, report error conditions, or any combination thereof. However, the TLS protocol, including the sub-protocols, may fail to indicate similarities between servers to the client. For example, if the client identifies a server related to malware, the client may not be able to determine whether another server is related to the same malware based on the TLS protocol. This may potentially result in security concerns for the clients.

TLS fingerprinting refers to the process of identifying or categorizing TLS connections based on their unique characteristics or parameters. TLS is a cryptographic protocol used to secure communication over the internet, commonly seen in HTTPS connections.

TLS fingerprinting techniques involve examining various attributes of a TLS handshake, such as the version of TLS being used, supported cipher suites, and other parameters exchanged during the initial connection setup. By analyzing these characteristics, it is possible to create a fingerprint or signature that can help identify or classify the specific implementation or configuration of TLS.

TLS fingerprinting can have various applications. It can be used for network traffic analysis, intrusion detection, or to identify specific software or devices based on their TLS behavior.

The TLS fingerprinting process can be active or passive. How the fingerprinting process is conducted and the level of interaction with the TLS connections determine the difference between active and passive TLS fingerprinting.

Passive TLS fingerprinting refers to observing and analyzing TLS connections without actively participating in the communication. In this approach, an observer, such as a network-monitoring tool, captures network traffic and examines the characteristics of the TLS handshakes. The observer collects information about the TLS version, cipher suites, and other handshake parameters to build a fingerprint. Passive TLS fingerprinting does not interfere with the communication itself.

On the other hand, active TLS fingerprinting involves actively initiating TLS connections and engaging in the handshake process. Active fingerprinting techniques usually send specific requests to a target system and analyze the responses to extract TLS parameters. This method may involve sending crafted packets or exploiting certain behaviors to trigger unique responses. Active fingerprinting can provide more detailed information about the target system TLS configuration, but it requires direct interaction with the system, potentially generating additional network traffic and interfering with network communications. Nonetheless, active fingerprinting is valuable for certain applications.

Although useful in some applications, TLS fingerprinting is only one piece of the informational puzzle. Thus, there is a need for a more complete picture of network traffic, including wireless device traffic, wherein TLS fingerprints represent one kind of component in that overall picture.

### SUMMARY OF THE DISCLOSURE

One method of categorizing computer network communications according to an embodiment of the disclosure comprises the following steps. Data relating to a communication over a computer network is received. Information from the communication is extracted and organized into at least one digital component footprint. The component footprint comprises a text string that is delimited into a plurality of sections, wherein at least one of the sections is human-readable. The component fingerprint is then output for analysis.

These and other further features and advantages of the invention would be apparent to those skilled in the art from the following detailed description, taken together with the accompanying drawings.

### BRIEF DESCRIPTION OF THE DRAWINGS

The features and advantages of the various exemplary embodiments will become apparent from the following detailed description when considered in conjunction with the accompanying drawings. Where possible, the same reference numerals and characters are used to denote like features, elements, components or portions of the inventive embodiments. It is intended that changes and modifications can be made to the described and shown exemplary embodiments without departing from the true scope and spirit of the inventive embodiments described herein as defined by the claims.

FIG. 1a is a diagram illustrating a method of generating a component fingerprint according to an embodiment of the present disclosure.

FIG. 1b is a computer screenshot showing data used in generating component fingerprints according to embodiments of methods/systems of the present disclosure.

FIG. 1c is a computer screenshot showing data used in generating component fingerprints according to embodiments of methods/systems of the present disclosure.

FIG. 1d is a table containing information related to exemplary JA4C component fingerprints according to methods/systems of the present disclosure.

FIG. 1e is a computer screenshot showing data used in generating component fingerprints according to embodiments of methods/systems of the present disclosure.

FIG. if is a computer screenshot showing data used in generating component fingerprints according to embodiments of methods/systems of the present disclosure.

FIG. 1g is a computer screenshot showing data used generating component fingerprints according to embodiments of methods/systems of the present disclosure.

FIG. 1h is a computer screenshot showing data used in generating component fingerprints according to embodiments of methods/systems of the present disclosure.

FIG. 2a is a diagram of a method illustrating generating a component fingerprint according to an embodiment of the present disclosure.

FIG. 2b is a computer screenshot showing data used in generating component fingerprints according to embodiments of methods/systems of the present disclosure.

FIG. 2c is a table containing information related to exemplary JA4 and JA4S component fingerprint combinations according to methods/systems of the present disclosure.

FIG. 3a is a diagram illustrating a method of generating a component fingerprint according to an embodiment of the present disclosure.

FIG. 3b is a table containing information related to exemplary hop counts and propagation delay factors used in generating component fingerprints according to methods/systems of the present disclosure.

FIG. 3c is a computer screenshot showing data used in generating component fingerprints according to embodiments of methods/systems of the present disclosure.

FIG. 3d is a computer screenshot showing data used in generating component fingerprints according to embodiments of methods/systems of the present disclosure.

FIG. 3e is a computer screenshot showing data used in generating component fingerprints according to embodiments of methods/systems of the present disclosure.

FIG. 3f is a map showing information related to an exemplary component fingerprint according to methods/systems of the present disclosure.

FIG. 3g is a computer screenshot showing data used in generating component fingerprints according to embodiments of methods/systems of the present disclosure.

FIG. 3h is a computer screenshot showing data used in generating component fingerprints according to embodiments of methods/systems of the present disclosure.

FIG. 3i is a map showing information related to an exemplary component fingerprint according to methods/systems of the present disclosure.

FIG. 4a is a computer screenshot showing data used in generating component fingerprints according to embodiments of methods/systems of the present disclosure.

FIG. 4b is a table containing information related to exemplary common TCP options used in generating component fingerprints according to methods/systems of the present disclosure.

FIG. 4c is a table containing information related to exemplary maximum transmission units used in generating component fingerprints according to methods/systems of the present disclosure.

FIG. 4d is a diagram illustrating a method of generating a component fingerprint according to an embodiment of the present disclosure.

FIG. 4e is a table containing information related to exemplary JA4T component fingerprints generated according to methods/systems of the present disclosure.

FIG. 4f is a table containing information related to exemplary carrier MSS figures used in generating component fingerprints according to methods/systems of the present disclosure.

FIG. 4g is a table containing information related to exemplary JA4T component fingerprints generated according to methods/systems of the present disclosure.

FIG. 4h is a table containing information related to exemplary JA4T component fingerprints generated according to methods/systems of the present disclosure.

FIG. 5 is a table containing information related to exemplary JA4TS component fingerprints generated according to methods/systems of the present disclosure.

FIG. 6a is a computer screenshot showing data used in generating component fingerprints according to embodiments of methods/systems of the present disclosure.

FIG. 6b is a computer screenshot showing data used in generating component fingerprints according to embodiments of methods/systems of the present disclosure.

FIG. 6c is a table containing information related to exemplary JA4TScan component fingerprints generated according to methods/systems of the present disclosure.

FIG. 7a is a table containing information related to exemplary internet scanners that can be blocked according to methods/systems of the present disclosure.

FIG. 7b is a screenshot showing data related to exemplary internet scanners that can be blocked according to methods/systems of the present disclosure.

FIG. 7c is a screenshot showing data related to exemplary internet scanners that can be blocked according to methods/systems of the present disclosure.

FIG. 7d is a screenshot showing data related to exemplary internet scanners that can be blocked according to methods/systems of the present disclosure.

FIG. 8a is a diagram illustrating a method of generating a component fingerprint according to an embodiment of the present disclosure.

FIG. 8b is a table containing information related to exemplary JA4H component fingerprints generated according to methods/systems of the present disclosure.

FIG. 9a is a diagram illustrating a method of generating a component fingerprint according to an embodiment of the present disclosure.

FIG. 9b is a screenshot showing data related to generating component fingerprints according to methods/systems of the present disclosure.

FIG. 9c is a screenshot showing data related to generating component fingerprints according to methods/systems of the present disclosure.

FIG. 9d is a table containing information related to exemplary JA4X component fingerprints generated according to methods/systems of the present disclosure.

FIG. 9e is a screenshot showing data related to generating component fingerprints according to methods/systems of the present disclosure.

FIG. 9f is a table containing information related to generating JA4X component fingerprints according to methods/systems of the present disclosure.

FIG. 10a is a diagram illustrating a method of generating a component fingerprint according to an embodiment of the present disclosure.

FIG. 10b is a screenshot showing data related to generating component fingerprints according to methods/systems of the present disclosure.

FIG. 11 is a table containing information related to generating component fingerprints according to methods/systems of the present disclosure.

### DESCRIPTION OF THE DISCLOSURE

Embodiments of the disclosure are directed to a suite of network fingerprints that can be used to identify and analyze network traffic. Such fingerprints may include, for example, a client TLS fingerprint, a server TLS fingerprint, a certificate fingerprint, an HTTP fingerprint, a distance/location fingerprint, an SSH traffic fingerprint, and a wireless device fingerprint. Taken together, these component fingerprints make up a composite fingerprint that can provide valuable information about network traffic. It is understood that the fingerprint components disclosed herein are merely exemplary. That is, many other component fingerprints are possible which may contribute to the composite fingerprint discussed herein.

Embodiments of the disclosure, referred to generally as JA4+, allow for the detection and prevention of malware or other undesirable programs from communicating over the network. JA4+ includes a suite of modular network fingerprints that are easy to use and easy to share. These fingerprints are both human- and machine-readable to facilitate more effective threat-hunting and analysis. As used throughout this disclosure, the term “human-readable” means that information is easily understood by a human being without having to resort to machine decoding or complex database reference. In other words, the information, for example a text string, is capable of being understood by a human at a glance with cursory prior reference to a key. The human-readable nature of the information makes it easy for users with a minimal familiarity with the key to immediately understand basic characteristics of the information presented for purposes of analysis, sharing, discussion, etc. In this way, most of the component fingerprints disclosed herein comprise at least one human-readable section. The use cases for these fingerprints, include, for example, scanning for threat actors, malware detection, session hijacking prevention, compliance automation, location tracking, DDoS detection, grouping of threat actors, reverse shell detection, and other applications.

Throughout this description, preferred embodiments and examples illustrated should be considered as exemplars, rather than as limitations on the present invention. As used herein, the term “invention,” “device,” “method,” “disclosure,” “present invention,” “present device,” “present method,” or “present disclosure” refers to any one of the embodiments of the invention described herein, and any equivalents. Furthermore, reference to various feature(s) of the “invention,” “device,” “method,” “disclosure,” “present invention,” “present device,” “present method,” or “present disclosure” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Relative terms such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc., may be used herein to describe various elements, components, or steps, these elements, components, or steps should not be limited by these terms. These terms are only used to distinguish one element, component, or step from another element, component, or step. Thus, a first element or component discussed below could be termed a second element or component without departing from the teachings of the present disclosure. As used herein, the term “and/or” includes any and all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “having,” and similar terms, when used herein, specify the presence of stated features, integers, steps, operations, elements, and/or components, but do not preclude the presence or addition of one or more other features, integers, steps, operations, elements, components, and/or groups thereof.

For ease of reference, the various component fingerprints are referred to herein as follows:
JA4C=TLS Client Fingerprint;
JA4S=TLS Server Response/Session Fingerprint;
JA4X=X509 TLS Certificate Fingerprint;
JA4H=HTTP Client Fingerprint;
JA4L=Latency Measurement Distance/Location Fingerprint;
JA4T=Passive TCP Client Fingerprint;
JA4TS=Passive TCP Server Response Fingerprint;
JA4SSH=SSH Traffic Fingerprint;
JA4W=Wireless Device Fingerprint; and
JA4TScan=Active TCP Server Fingerprint.
   Some of these component fingerprints are discussed in more detail herein. Each of these component fingerprints contribute to the composite fingerprint which provides an informational snapshot of traffic across network connections. All of these, in combination or individually, allow for detection and prevention of session hijacking, depending on the method or tools used in session hijacking. Various methods and systems of compiling and using the composite fingerprint described herein may be referred to as JA4+ for ease of reference. The term JA4+ may also be used to describe the component fingerprints or the composite fingerprints, which may include some or all of the various component fingerprints.

JA4+ fingerprints may be presented in an a_b_c format, delimiting the different sections that make up the fingerprint. This allows for hunting and detection utilizing just ab or ac or c only. For example, if a user wants to just do analysis on incoming cookies into an app, the user could look at JA4H_c only. This locality-preserving format facilitates deeper and richer analysis while remaining simple, easy to use, and allowing for extensibility.

### JA4C: TLS Client Fingerprint

TLS is used to encrypt the vast majority of traffic on the internet, from web browsing to streaming, to IoT usage analytics. Even malware uses TLS to hide malicious communications. At the beginning of a TLS connection, the client sends a TLS Client Hello packet which is sent in the clear, prior to encrypted communication. This packet, generated by the client application, informs the server of what ciphers it supports as well as its preferred method of communication. As such, the TLS Client Hello packet is unique per application or its underlying TLS library. JA4C draws information from the TLS Client Hello packet and builds a fingerprint of the client based on attributes within the packet.

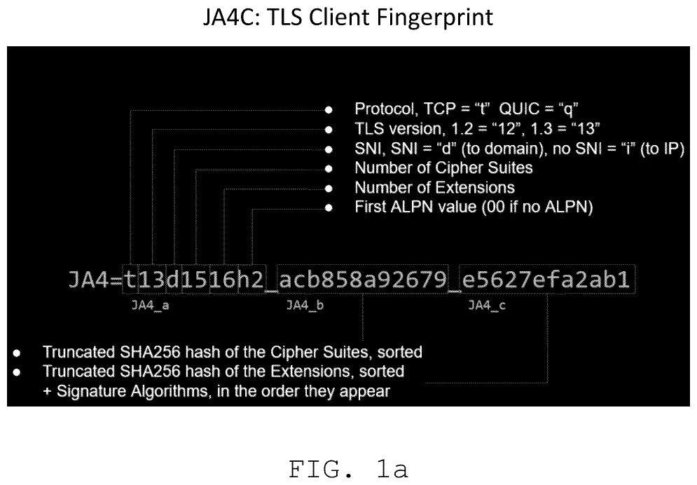

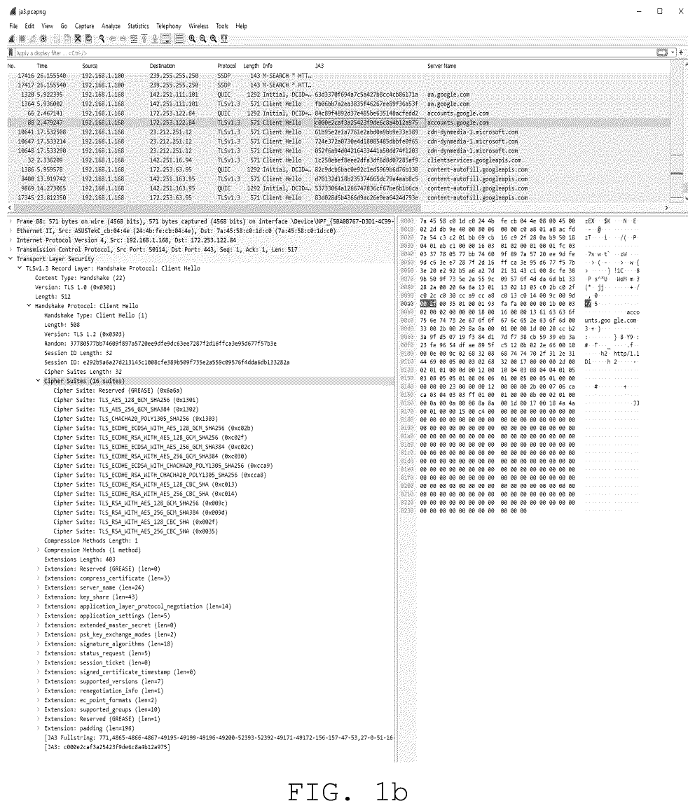

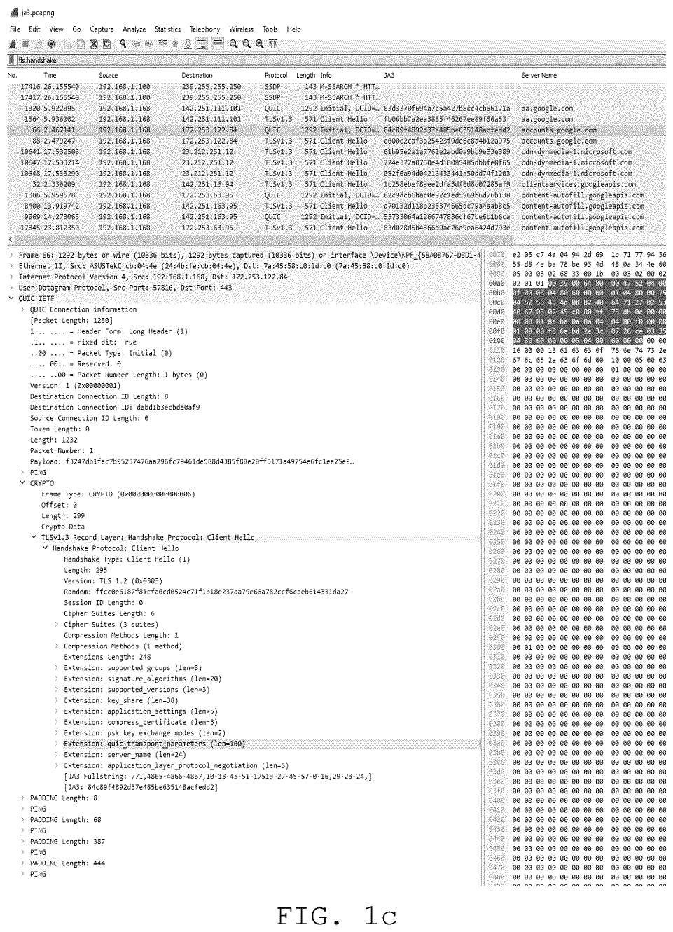

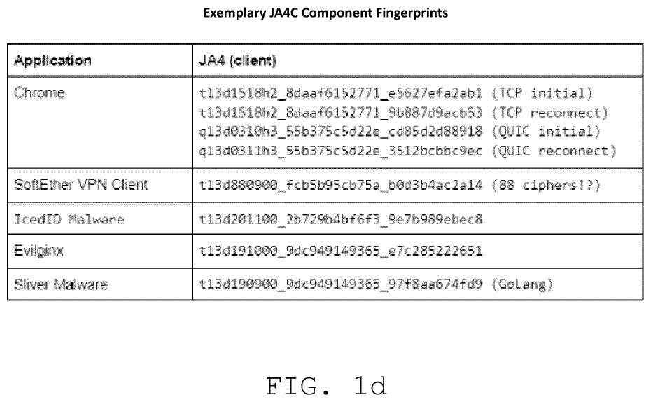

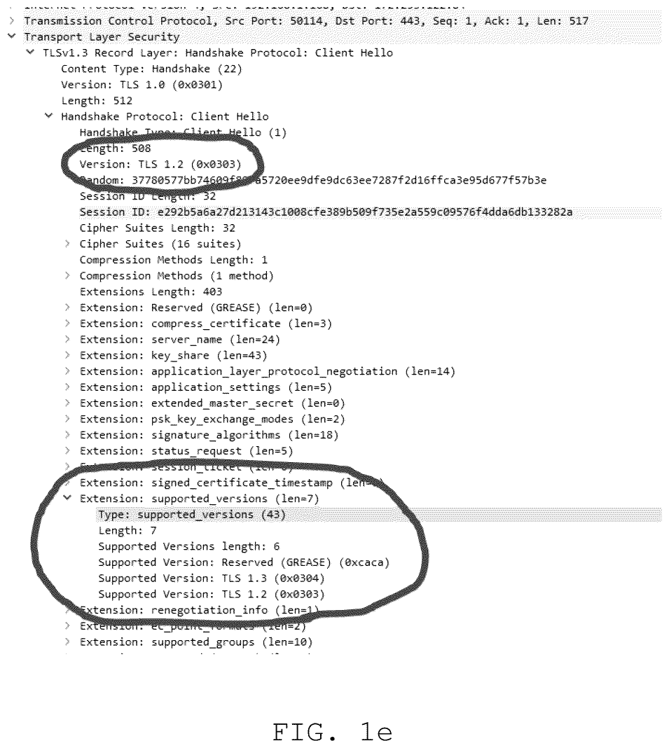

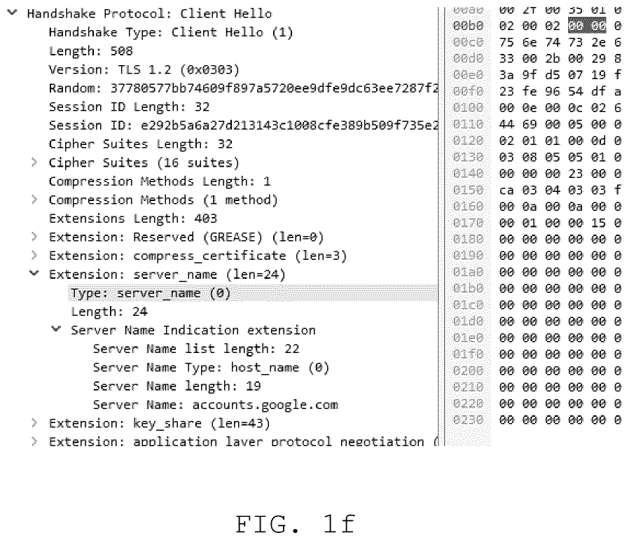

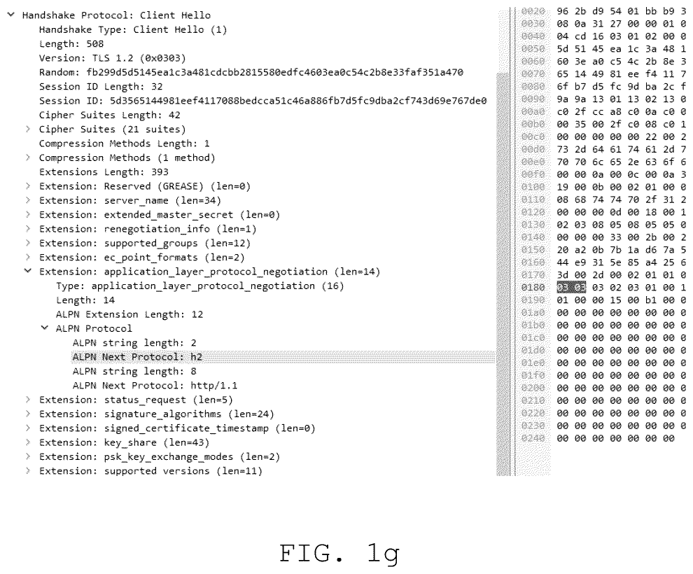

FIG. 1a is a diagram illustrating a method of generating a JA4C component fingerprint according to an embodiment of the present disclosure. Here, the first section (i.e., JA4C_a) is human-readable. That is, a human can look at the first section of the component fingerprint and immediately understand some basic characteristics of the information contained therein with only cursory prior reference to a key, e.g., FIG. 1a itself. The user does not have to submit the section to a machine for database look-up. Once the user has familiarity with the key, he/she can understand the information at a glance, which facilitates analysis, sharing, discussion, etc. of the various component fingerprints among users.

FIGS. 1b and 1c are computer screenshots showing steps in an exemplary implementation of the JA4C component fingerprint. FIG. 1d shows a table that includes several exemplary JA4C component fingerprints.

JA4C fingerprints the client, no matter if the traffic is over TCP or QUIC. QUIC is the protocol used by the new HTTP/3 standard that encapsulates TLS 1.3 into UDP packets. JA4C also clearly shows the ALPN (Application-Layer Protocol Negotiation). This represents the protocol that the application wants to communicate in after the TLS negotiation is complete. “h2”=HTTP/2, “h1”=HTTP/1.1, “dt”=DNS-over-TLS, etc. A “00” here denotes the lack of ALPN. Note that the presence of ALPN “h2” does not indicate a browser as many IoT devices communicate over HTTP/2. However, the lack of an ALPN may indicate that the client is not a web browser.

Even though the traffic is encrypted over TLS 1.3, it is still possible to gain valuable information about the client application. Most custom applications will have the fingerprint of their underlying TLS libraries. So, for example, a program written in Go will likely have a JA4C component fingerprint that matches other Go programs. The same is true for Python, Java, etc.; however, custom programs like VPN clients, Steam, Slack, and Windows functions will be unique.

JA4C is valuable in production networks where applications are largely static. If a user is running an all Linux infrastructure, then a Windows JA4C fingerprint might trigger closer analysis. If a user is running only Exchange servers, then a sudden python JA4C fingerprint might trigger closer analysis. JA4C provides a valuable pivot point in analysis when trying to understand network traffic and the a_b_c format allows for deeper analysis.

For example, an internet listener that identifies internet scanners may implement JA4+ into its system. An actor that scans the internet with a constantly changing single TLS cipher will generate a large amount of completely different fingerprints, only the b part of the JA4C fingerprint changes, parts a and c remain the same. As such, the internet listener can track the actor by looking at the JA4C_ac fingerprint (joining a+c, dropping b).

One embodiment of the JA4C algorithm is described as follows: (QUIC=“q” or no QUIC=“t”) (2 character TLS version) (SNI=“d” or no SNI=“i”) (2 character count of ciphers) (2 character count of extensions) (sha256 hash of the list of cipher hex codes in the order they appear, truncated to 12 characters) (sha256 hash of the list of extension hex codes sorted in hex order, truncated to 12 characters.)

The end result is a 32-character fingerprint, which in this case is presented as: t13d1516acb858a92679b186095e22b6.

The program may need to ignore GREASE (Generate Random Extensions And Sustain Extensibility) values anywhere it encounters them. GREASE has been described by some as a mechanism to prevent extensibility failures in the TLS ecosystem. GREASE values are TLS protocol values which have been randomized/reordered to discourage server implementations from conditioning on them. In most instances, these values should be ignored in generating the various component fingerprints.

It is understood that other informational components can also be considered when generating a fingerprint. The various informational components in this particular embodiment of a JA4C fingerprint are now discussed.

QUIC: TLS over QUIC is essentially TLS over User Datagram Protocol (UDP). QUIC contains a TLS Client Hello packet within the QUIC protocol. Not every program can identify QUIC, much less extract the TLS Client Hello. But when it is possible, the extension shown in the computer screenshot shown in FIG. 1c indicates if the client is using QUIC or not. So, if that extension 0x0039 exists, then the first character of the JA4C fingerprint is “q”; if not, it is “t”.

TLS Version: With reference to the screenshot shown in FIG. 1e, the TLS version is shown in three different places. If extension 0x002b exists (supported_versions), then the version is the highest value in the extension. Again, GREASE values should be ignored. If the extension does not exist, then the TLS version is the value of the Protocol Version. The handshake version (located at the top of the packet) should be ignored.

$$0 \times 0304 = TLS 1.3 = “ 13 ”$$

$$0 \times 0303 = TLS 1.2 = “ 12 ”$$

$$0 \times 0302 = TLS 1.1 = “ 11 ”$$

$$0 \times 0301 = TLS 1. = “ 10 ”$$

$$0 \times 0300 = SSL 3. = “ s 3 ”$$

$$0 \times 0200 = SSL 2. = “ s 2 ”$$

$$0 \times 0100 = SSL 1. = “ s 1 ”$$

$$Unkown = “ 00 ”$$

SNI: With reference to the screenshot shown in FIG. 1f, if the SNI extension (0x0000) exists, then the destination of the connection is a domain, or “d” in the fingerprint. If the SNI does not exist, then the destination is an IP address, or “i”.

Number of Ciphers: The number of cipher suites may be expressed with two characters such that if there are 6 cipher suites in the hello packet, then the value should be “06”. If there are greater than 99, which there should never be, then output “99”. This ignores GREASE values; they do not count.

Number of Extensions: This works the same way as counting ciphers, again ignoring GREASE values.

Application-Layer Protocol Negotiation (ALPN) Extension Value: The first and last characters of the ALPN first value. With reference to the screenshot in FIG. 1g, the first ALPN value is h2, so the first and last characters are “h2”. If the first ALPN listed was http/1.1, then the first and last characters would be “h1”. In Wireshark, for example, this field is located under tls.handshake.extensions_alpn_str. If there are no ALPN values or no ALPN extension, then “00” is provided as the component fingerprint value.

Cipher hash: A twelve-character truncated sha256 hash of the list of ciphers in the order they appear, first twelve characters. The list is created using the four character hex values of the ciphers, comma delimited, ignoring GREASE values. For example:
1301, 1302, 1303, c02b, c02f, c02c, c030, cca9, cca8, c013, c014, 009c, 009d, 002f, 0035=acb858a92679

Extension hash: A twelve-character truncated sha256 hash of the list of extensions, sorted by hex value, followed by a list of signature algorithms, in the order they appear (i.e., unsorted). The extension list is created using the four-character hex values of the extensions, lower case, comma delimited, sorted (i.e., not in the order they appear). For example:
001b, 0000, 0033, 0010, 4469, 0017, 002d, 000d, 0005, 0023, 0012, 002b, ff01, 000b, 000a, 0015
   This list is sorted to:
0005, 000a, 000b, 000d, 0012, 0015, 0017, 001b, 0023, 002b, 002d, 0033, 4469, ff01
   Note that 0000 and 0010 have been removed from the sorted list. The signature algorithm hex values are then added to the end of the list in the order that they appear (i.e., unsorted) with an underscore delimiting the two lists. For example, if the signature algorithms are:
0403, 0804, 0401, 0503, 0805, 0501, 0806, 0601
   then, these values are added to the end of the previous string to create:
0005, 000a, 000b, 000d, 0012, 0015, 0017, 001b, 0023, 002b, 002d, 0033, 4469, ff01_0403, 0804, 0401, 0503, 0805, 0501, 0806, 0601
   This combined list is hashed to:
e5627efa2ab19723084c1033a96c694a45826ab5a460d2d3fd5ffc fe97161c95
   and then truncated to the first 12 characters:
e5627efa2ab1
   If there are no signature algorithms in the hello packet, then the string ends without an underscore and is hashed. For example:
0005, 000a, 000b, 000d, 0012, 0015, 0017, 001b, 0023, 002b, 002d, 0033, 4469, ff01=6d807ffa2a79

With reference to the screenshot shown in FIG. 1h, an exemplary packet is presented for analysis. In this particular packet, the JA4C fingerprint would present as follows:

t (TLS over TCP)
13 (TLS version 1.3)
d (SNI exists so it is going to a domain)
15 (15 cipher suites ignoring GREASE)
16 (16 extensions ignoring GREASE)
h2 (first and last characters of the ALPN extension value)
“_”
8daaf6152771 (truncated sha256 hash of the list of ciphers
sorted)
“_”
e5627efa2ab1 (truncated sha256 hash of the list of
extensions sorted, SNI and ALPN removed, followed by the
list of signature algorithms)
JA4C = t13d1516h2_acb858a92679_e5627efa2ab1

### JA4S TLS Server Fingerprint

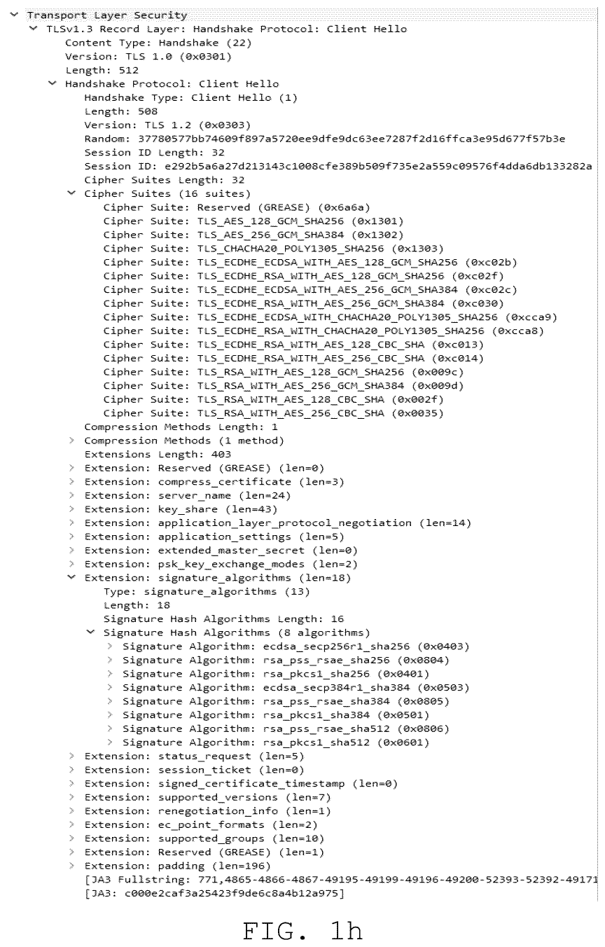

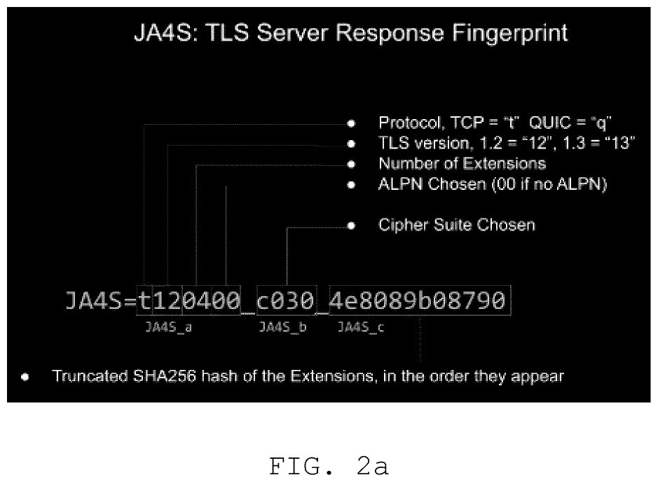

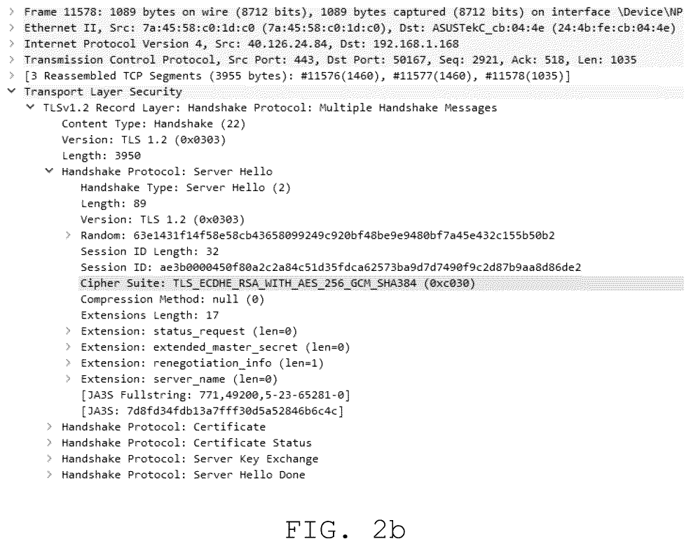

FIG. 2a is a diagram illustrating a method of generating a JA4S component fingerprint according to an embodiment of the present disclosure. JA4S, possibly in combination with other component fingerprints, allows for fingerprinting of TLS connections between clients and servers, facilitating higher fidelity detection and prevention of malware or undesirable programs from communicating on the network.

After a client sends its TLS Client Hello packet, the server will respond with its TLS Server Hello packet. This packet, also sent in the clear, is formulated based on the selection by the server of available options in the Client Hello. This includes the one cipher chosen out of the list of available options and any extensions the server wishes to set. As such, the Server Hello is unique to both the server application and the Client Hello that was sent to it. A different Client Hello may cause a different Server Hello, and therefore a different JA4S component fingerprint, from the same server. However, the same Client Hello will always produce the same Server Hello from that server application. For example, if the client sends JA4C=a_b_c and the server responds with JA4S=d_b_e, that server will always respond to a_b_c with d_b_e. But if another application sends a different Client Hello to that same server, say JA4C=x_y_z, the server will respond with a different server hello, JA4S=t_y_v. So there may be a different response to different applications but always the same response to the same application.

One suitable format for the component fingerprint is as follows:
(q or t) (2 character TLS version) (2 character number of extensions) (first and last character of the ALPN chosen)_(cipher suite chosen in hex)_(truncated sha256 hash of the extensions in the order that they appear)

In the Server Hello packet, there is always a single cipher, the cipher that the server chose to communicate in. So with JA4S, there is no need to count the number of ciphers or to hash them; instead, the chosen cipher is simply shown. Also with Server Hellos, the extensions are not being randomized, which means that those values can be hashed in the order they appear rather than having to sort them first.

An exemplary Server Hello is shown in the computer screenshot in FIG. 2b. For this particular Server Hello, the JA4S component fingerprint would be:

t (TLS over TCP)
12 (no supported versions extension here, so this is x0303,
TLS 1.2)
04 (4 extensions)
00 (first and last character of the ALPN chosen by the
server, 00 here as there's no ALPN extension)
“_”
c030 (the cipher suite chosen by the server in hex)
“_”
4e8089b08790 (truncated sha256 hash of the extensions in
the order they were seen)
JA4S = t120400_c030_4e8089b08790

The table shown in FIG. 2c lists some exemplary JA4C and JA4S component fingerprint combinations.

JA4S, when combined with JA4C, significantly increases detection fidelity by going beyond mere identification of underlying libraries of a client to identification of the client or malware family. Beyond application identification, a user could analyze just JA4S_b to understand what ciphers are being used on any given network, for example, to ensure it is meeting compliance requirements. All of this is possible without breaking encryption.

### JA4L: Light Distance

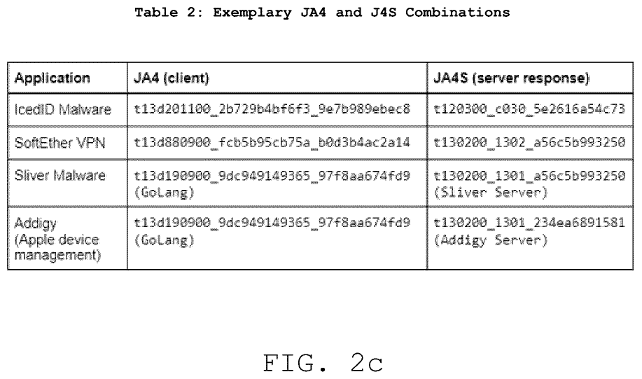

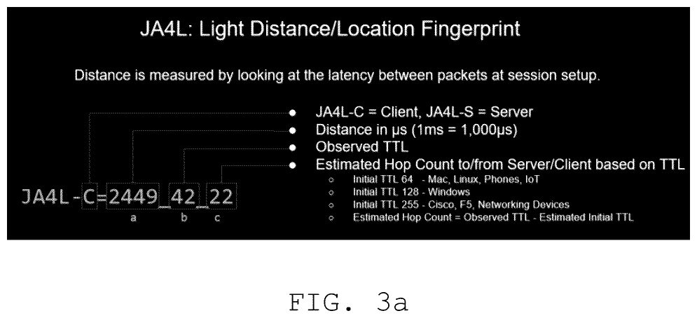

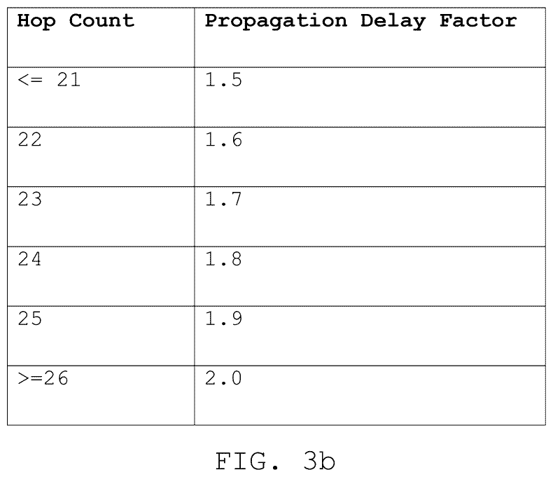

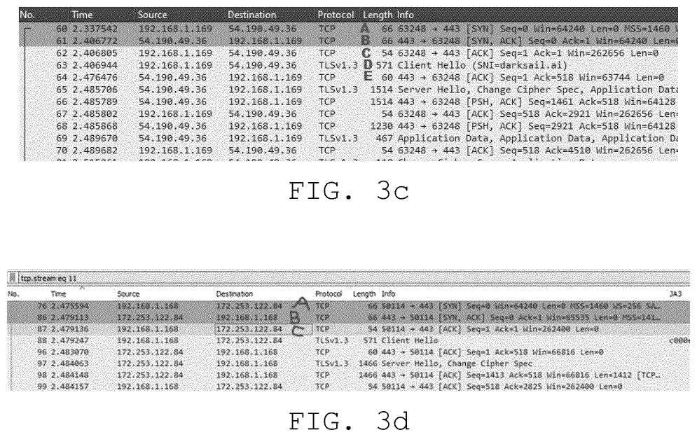

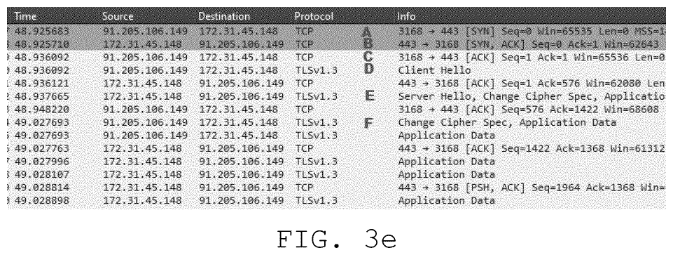

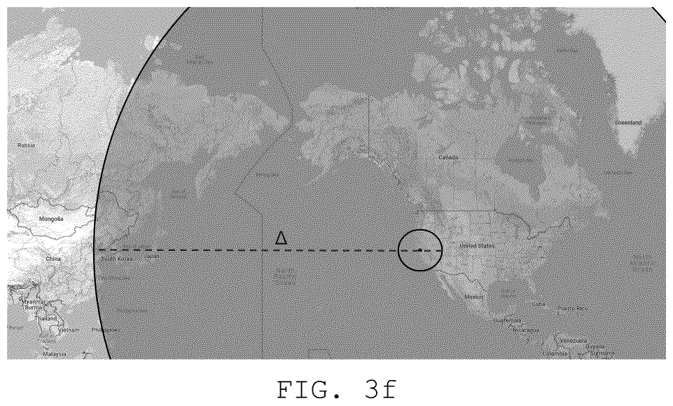

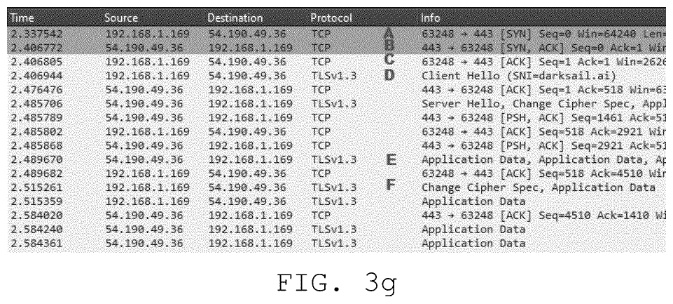

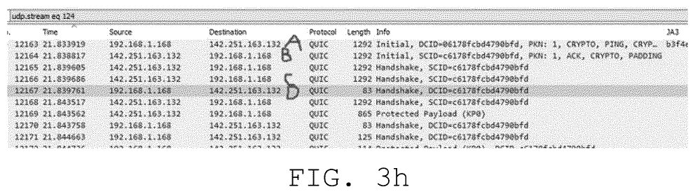

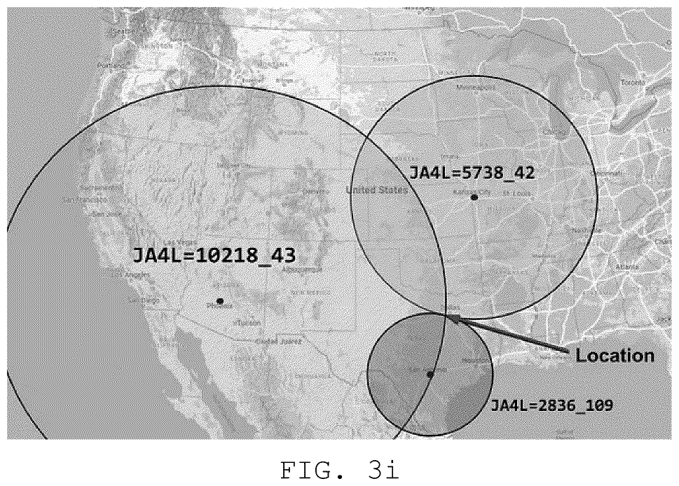

FIG. 3a is a diagram illustrating a method of generating a JA4L component fingerprint according to an embodiment of the present disclosure. JA4L allows for passively identifying the distance between a client and a server as well as how many network hops were observed between the client and server. This allows for the geolocation of a server or client.

JA4L measures the light distance/latency between the first few packets in a connection. The first few packets are analyzed as these are low-level machine-generated packets, so there is nearly zero processing delay in creating and sending these packets. This essentially measures the estimated distance between the client and server. Time is measured in microseconds (μs), which are the standard unit of time measurement in packet captures.

If the packet capture/program is running server side, it will measure the distance of the client from the server. If it is running client side, this will measure the distance of the server from the client. If it is running on a network tap, it will measure the distance of both from the network tap location. In that instance the distance of the client from the server can be measured by summing JA4L-C and JA4L-S parts a and c.

JA4L is split up into two measurements, client (JA4L-C) and server (JA4L-S). For TCP, these are determined by looking at the TCP 3-way handshake and the protocol handshake. For UDP, the QUIC (HTTP/3) handshake is analyzed.

With most VPNs, the VPN exit node handles TCP handshakes and TCP bare packets (packets without payloads), such as ACK, FIN, etc. The application handshake is handled by the client.

TCP: With reference to the screenshot in FIG. 3c, one embodiment of the JA4L method operates as follows. In the TCP 3-way handshake, first the client sends a SYN packet. The timestamp that the SYN packet is seen is captured by the program as value “A”. Additionally, the IPv4 TTL or IPv6 Hop Count from the client is captured (e.g., field “ip.ttl” in Wireshark). Then the server responds with a SYN ACK packet. The timestamp of that packet is value “B”. Additionally, the IPv4 TTL or IPv6 Hop Count from the server is captured. Next, the client will respond with an ACK packet, thus completing the TCP 3-way handshake. The timestamp of that packet is value “C”.

The client will then send the next packet, which is the application protocol packet. For example, with TLS, the next packet is the TLS Client Hello packet. With SSH, the next packet is the Client Protocol. This next packet following the TCP handshake is captured as value “D”.

The server will respond with its next packet, usually a TCP ack packet. This is captured as value “E”.

The associated fingerprint components are calculated as follows:

$$JA 4 L - C = \{ ( C - B ) / 2 \} \_Client TTL\_ \{ ( D - B ) / 2 \}$$

$$a\_b \_c$$

$$JA 4 L - S = \{ ( B - A ) / 2 \} \_Server TTL\_ \{ ( E - D ) / 2 \}$$

$$a\_b \_c$$

where:
part a is the one-way latency within the TCP handshake;
part b is the observed TTL; and
part c is the one-way latency outside of the TCP handshake.
   In the above example:

$$JA 4 L - C = 33 \_ 128 \_ 172$$

$$JA 4 L - S = 69230 \_ 35 \_ 69532$$

In another example, part c may be eliminated from the fingerprint. With reference to the screenshot in FIG. 3d, the following calculations can be made:

$$A 4 L - C = \{ ( C - B ) / 2 \} \_Client TTL$$

$$JA 4 L - S = \{ ( B - A ) / 2 \} \_Server TTL$$

Using the exemplary data from FIG. 3d, the following component fingerprints are generated:

$$JA 4 L - C = 11 \_ 128$$

$$JA 4 L - S = 1759 \_ 42$$

With JA4L, the distance between the client and server can be determined, using the following formula:

$$D = jc / p ,$$

$$wherein$$

$$D = distance ;$$

$$j = JA 4 L ;$$

$$c = speed of light in miles per μ s in fiber ( 0.128 mi / μ s ) ;$$

$$and$$

$$p = propagation delay factor .$$

Typical propagation delay depends on terrain and how many networks are involved. Some exemplary values are provided below:

Poor terrain factor = 2 (e.g., near mountains or water);
Good terrain factor = 1.5 (e.g. along highways,
undersea cables;

The TTL may be used to calculate the hop count which can inform the propagation delay factor, as shown in the table of FIG. 3b. To calculate the number of hops a connection went through, the TTL is subtracted from its estimated initial TTL. Some exemplary TTL values are given as follows:

Cisco, F5, and other networking devices - TTL = 255;
Windows - TTL = 128;
Mac, Linux, phones, and most IOT devices - TTL = 64

Most routes on the Internet have less than 64 hops. Therefore, if the TTL value is within 65-128, the estimated initial TTL is 128. If the TTL value is 0-64, the estimated initial TTL is 64. And if the TTL is >128 then the estimated initial TTL is 255.

An observed TTL of 35 means the initial TTL was likely 64. Thus, the initial TTL is subtracted from the observed TTL to provide the hop count, here: 64−35=29.

According to embodiments of methods disclosed herein, with a JA4L-S value of 69230_35_69532, it can be estimated that the server is within 4,430 miles of the client. The server may be closer than this, but it is physically impossible for it to be farther away as the speed of light is constant.

$$69230 \times 0.128 / 2. = 4430$$

With reference to the screenshot in FIG. 3e, another embodiment of the JA4L fingerprinting component operates as follows.

In the TCP 3-way handshake, first the client sends a SYN packet. The timestamp that the syn packet is captured by the program as value “A.” Additionally, the IPv4 TTL or IPv6 Hop Count from the client is captured (field “ip.ttl” or “ipv6.hlim” in Wireshark).

The server responds with a SYN ACK packet. The timestamp of that packet is value “B.” Additionally, the IPv4 TTL or IPv6 Hop Count from the server is captured.

The client will respond with an ACK packet, thus completing the TCP 3-way handshake. The timestamp of that packet is value “C.”

The client will then send the next packet, which is the application packet. For example, with TLS, the next packet is the TLS Client Hello packet. With SSH, the next packet is the Client Protocol. This next packet following the TCP handshake is captured as value “D.” From here TCP bare packets such as ACK are ignored and only application packets (TCP packets with payloads) are considered.

The server will respond with its next packet or multiple packets. With TLS, this is a Server Hello packet, potentially followed by a Certificate or Change Cipher Spec packet from the server. With SSH, this is the server SSH protocol. The last packet sent from the server before the client sends a packet is captured as value “E.”

The application response from the client, the second application packet sent from the client, is captured as value “F.”

In the above screenshot example, the captured timestamps are as follows:

$$\begin{matrix}A = 48925683 \\ B = 48925710 \\ C = 48936092 \\ D = 48936092 \\ E = 48937665 \\ F = 49027693\end{matrix} \\ JA 4 L - C = \{ ( C - B ) / 2 \} \_Client TTL\_ \{ ( F - E ) / 2 \} \\ a\_b \_c \\ JA 4 L - S = \{ ( B - A ) / 2 \} \_Server TTL\_ \{ ( E - D ) / 2 \} \\ a\_b \_c$$

In the above example:

$$JA 4 L - C = 5191 \_ 42 \_ 45014$$

$$JA 4 L - S = 27 \_ 64 \_ 786$$

Part a is the one-way latency within the TCP handshake. Part b is the observed TTL. Part c is the one-way latency of the L7 application protocol negotiation.

If part c is significantly higher than part a, e.g., off by >2×magnitude above 2000, then the client is possibly connecting through a VPN, or the server is behind significant NAT infrastructure. In that case, the difference between part a and part c is the one-way latency between the client and VPN exit node, or the server and NAT infrastructure.

With JA4L we can determine the distance between the client and server using this formula:

$$D = jc / p ,$$

$$where :$$

$$D = Distance ;$$

$$j = JA4L\_a ( or delta between JA4L\_a and JA4L\_c in the case of VPNs ) ;$$

$$c = Speed of light per μ s in fiber ( 0.128 miles or 0.206 km per μ s ) ;$$

$$and$$

$$p = propagation delay factor .$$

Typical propagation delay depends on terrain as discussed previously herein. The TTL may be used to calculate the hop count which may inform the propagation delay factor. To calculate the number of hops a connection went through, the TTL is subtracted from its estimated initial TTL.

Cisco, F5, Some networking devices use a TTL of 255. Windows uses a TTL of 128. Mac, Linux, phones, and most IoT devices use a TTL of 64.

Most routes on the Internet have less than 64 hops. Therefore, if the TTL value is within 65-128, the estimated initial TTL is 128. If the TTL value is 0-64, the estimated initial TTL is 64. If the TTL is >128 then the estimated initial TTL is 255.

An observed TTL of 42 indicates that the initial TTL was likely 64. A TTL of 64-42 gives a hop count of 22.

Listening on the server side and with a JA4L-C of 5191_42_45014 and a delta of 39823 or 8.67× between parts a and c, it can be concluded that the client is connecting through a VPN, that the VPN exit node is within 415 miles of the server, and that the client is within 3185 miles of the VPN exit node.

5191x0.128/1.6=415 (distance of VPN exit node from server)
45014-5191=39823 (delta between client and VPN exit node)
39823x0.128/1.6=3185 (distance of client from VPN exit
node)

In this example, the VPN exit node was 402 miles from the server and the client was 3180 miles from the exit node as shown in the map screenshot of FIG. 3f.

With reference to the screenshot in FIG. 3g, another example of a JA4L fingerprinting component using TCP is provided below:
A=2337542
B=2406772
C=2406805
D=2406944
E=2489670
F=2515261
JA4L-C=16_128_12795
JA4L-S=34615 38 41363

It is noted that the last application packet from the server “E” before the client sends its second application packet “F” is several packets later in this example.

In this example, the program is listening on the client side. There is a significant delta between parts a and c for JA4L-C. This is due to processing delay on the client side and not due to VPN. This is why validating TCP latency deltas with JA4L on QUIC (below) is essential for confirming if a connection is over a VPN or if it is just due to application processing delay.

QUIC: QUIC is a general-purpose transport layer network protocol. With reference to the screenshot shown in FIG. 3h, QUIC setup spans several packets as shown in the screenshot below. First, the client sends an Initial QUIC Packet. This timestamp is indicated above as “A”. Then the server responds with its Initial QUIC Packet, with the timestamp indicated at “B”. Next, the server sends several handshake packets to the client. This could be 1-5 packets depending on the server. The last packet from the server before the client sends a packet is indicated as “C”. The program checks to see if the client has sent a second packet, if so, then the timestamp of the last packet that the server sent is “C”. Then the client's second packet, the handshake packet, is shown as “D”. Given this information the following calculations can be made:

$$JA 4 L - C = \{ ( D - C ) / 2 \} \_Client TTL\_q ;$$

$$and$$

$$JA 4 L - S = \{ ( B - A ) / 2 \} \_Server TTL\_q .$$

In the above example:

$$JA 4 L - C = 37 \_ 128 \_q$$

$$JA 4 L - S = 2449 \_ 42 \_q$$

$$2449 \times 0.128 / 1.6 = 195$$

Thus, using this method, the server is calculated to be within 195 miles of the client.

In this particular example, the server is located in Somerset, NJ, and the client is in Round Hill, VA. The actual distance is ˜194 miles. Thus, the component fingerprint provides a very good estimate of the actual distance between the server and the client.

Additionally, according to an embodiment of a method disclosed herein, using multiple locations, it is possible to passively triangulate the physical location of any client or server down to a city area. FIG. 3i is a screenshot of a map using an exemplary method that uses three distinct JA4L component fingerprints to triangulate a server location.

Additionally, JA4L_b (TTL) passively facilitates the identification of source operating systems, which is an excellent data point when performing forensic analysis. Also, because JA4L considers Layer 3 data, it works on both encrypted and unencrypted traffic.

Combining JA4C with JA4H and JA4L on the server side makes it possible for the server application to identify session hijacking or MiTM attacks. If a session cookie (JA4H_d) were to suddenly change locations, operating systems (JA4L), and application (JA4C and JA4H_ab), that would indicate that the session token should be revoked, prompting the user to log back in with multi-factor authentication (MFA). With this type of logic, special care should be taken to not put particular fingerprints on an allow list as applications will change over time, but instead to look for dramatic changes.

### JA4L for VPN and Proxy Networks

In another embodiment of the disclosure, methods and systems can be used to indicate that a particular client is connecting through a VPN or a proxy and to estimate the location of that client behind the VPN or proxy.

In VPN connections, a VPN exit node creates the TCP 3-way handshake between the exit node and the destination server. JA4L can measure this distance using various methods described herein. After the 3-way handshake, the next packet will actually come from the client, rather than from the VPN exit node. Therefore, JA4L can be extended to measure the distance between the client and the VPN exit node by measuring a difference between the latency in the TCP 3-way handshake (i.e., from the VPN exit node) and the latency in the next packet (i.e., from the client). If there is a significant delta between the latency in 3-way handshake and the first packet following the handshake, then it is probable that the client is behind a VPN and the delta can be used to calculate the distance from the client to the VPN exit node, using the J4L calculations provided above.

To corroborate this conclusion, the connection can be upgraded from TCP to QUIC, which operates over UDP. As there is no TCP handshake with QUIC, the VPN exit node just passes the packets. So, if the connection is over a VPN, the delta between the latencies associated with the TCP JA4L and the QUIC JA4L should be similar to the delta between the latencies of the TCP handshake and the next packet from the client. A similar delta would confirm the likelihood of a VPN/proxy connection and corroborate the distance of the client behind the VPN/proxy.

As noted throughout the disclosure, it is possible to use the combination of various fingerprinting components to identify and characterize connections. For example, JA4C (TLS client fingerprinting), JA4H (http client fingerprinting), and JA4T (TCP fingerprinting) with JA4L (the light distance/latency measurement) may be used to determine whether a particular client is connecting through a VPN/proxy by identifying inconsistent indications. For example, if JA4T indicates that a client is Linux while JA4C indicates a Windows client, then it may be assumed that the connection is via a VPN/proxy.

As discussed, the component fingerprints may be used individually or in combination to provide an indication that a particular connection is likely through a VPN/proxy and, further, to estimate the distances between the server, the VPN exit node, and the client. Information from the various component fingerprints can be combined to corroborate, or increase the likelihood of, a conclusion about a particular connection, in this case the existence of a VPN/proxy.

Accurately estimating the distance from a particular client to a destination server is important for several reasons. In one exemplary application, companies that offer subscription streaming services (e.g., Netflix, Disney+, MAX) need to reliably determine whether a particular client is within a given geographic zone in order to confirm that the client is authorized to access content associated with the client subscription. For example, if a client is requesting access to content from a United States (U.S.) company with a subscription that is limited to streaming within the U.S., then the company will want to reject a request from a client that is likely outside of the U.S. Thus, it would be useful for the company to accurately estimate the distance from the requesting client to the company's U.S. servers. While it is possible to obfuscate the total distance from a client to a destination server by increasing latency to create the appearance that a particular client is farther from the server than it actually is, it is not possible to create the appearance that the client is closer to the server than it actually is due to the natural limit of the speed of light. Importantly, in this particular exemplary application, companies are much more concerned with a client that appears closer than it actually is, that is, a client that appears to be within a certain geographic zone when it is not.

Similarly, government intelligence services need the ability to characterize a particular connection as originating outside the U.S. for purposes of authorizing surveillance under the Patriot Act or similar laws. Information gleaned from the various JA4+ component fingerprints, in particular JA4L, would be useful in this regard.

### JA4T: Transmission Control Protocol (TCP)

The Transmission Control Protocol (TCP) is one of the main protocols of the Internet protocol suite. TCP provides reliable, ordered, and error-checked delivery of a stream of packets between applications running on hosts communicating via an IP network.

To further identify VPNs and proxies, TCP packet attributes may be used. These different attributes will make up a new fingerprint component method called JA4T. For example, one such attribute is the maximum transmission unit (MTU). The MTU is almost always set to 1460. If the MTU is lower than 1460, it is even more likely that the connection is going over a VPN. These attributes can also help identify the operating system of the system sending the packets.

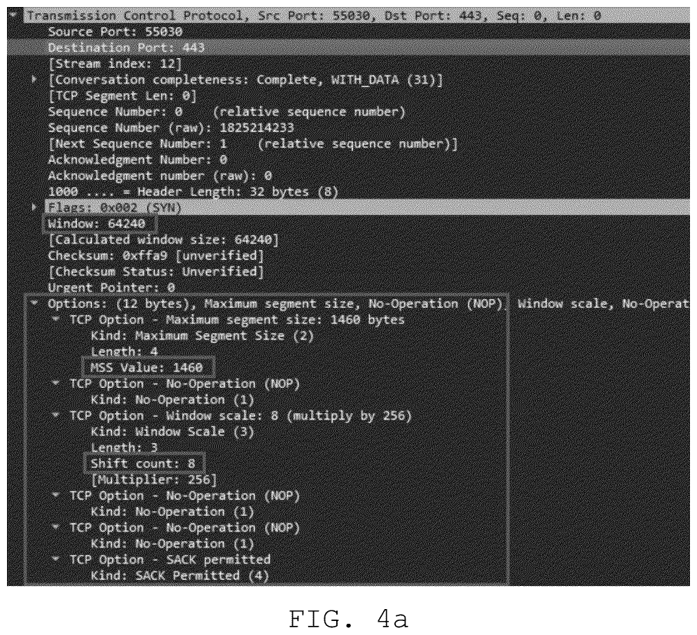

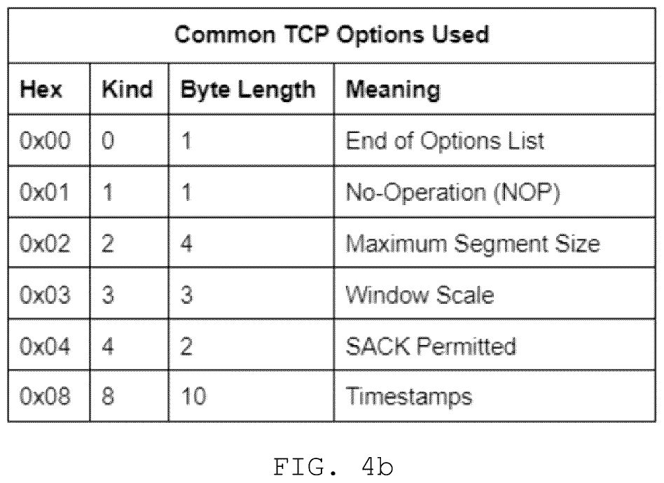

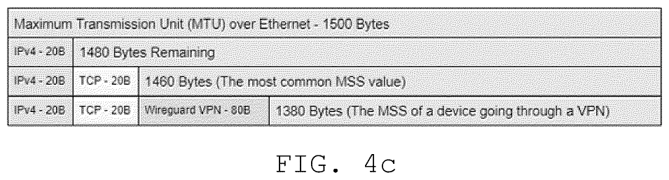

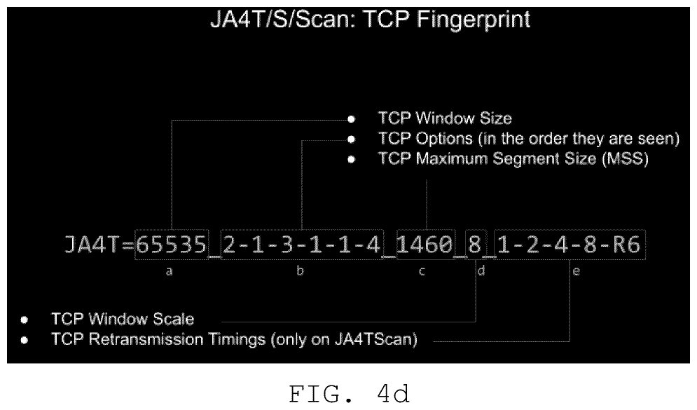

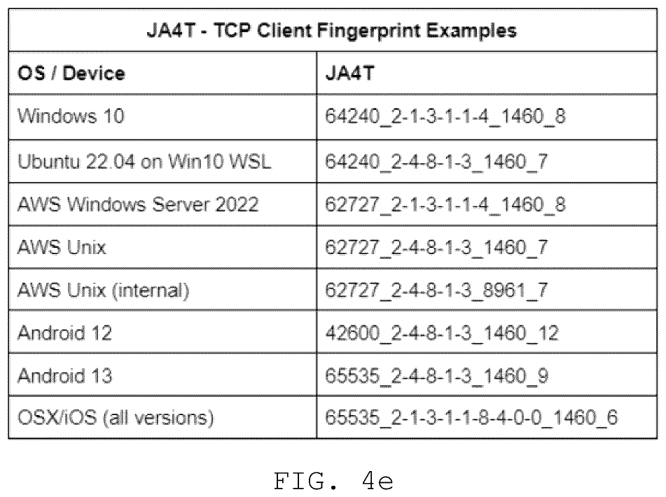

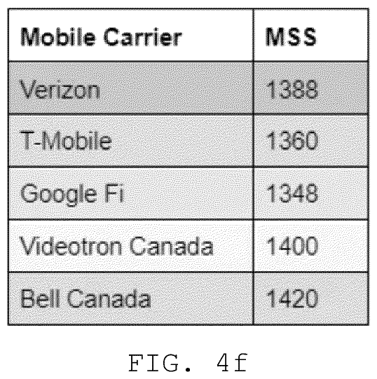

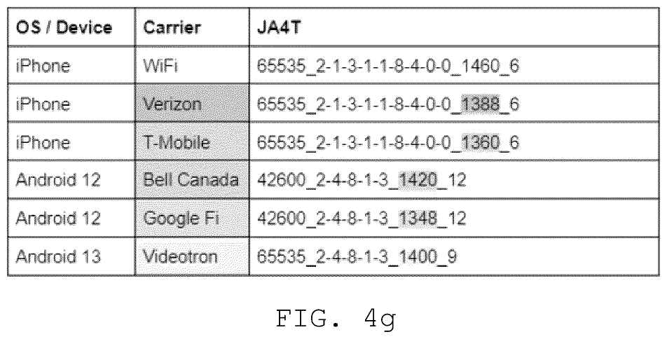

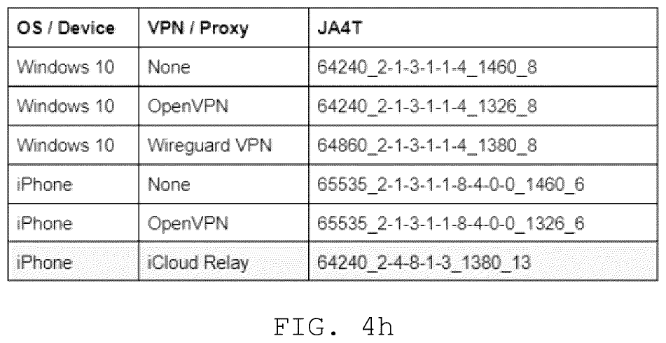

With reference to the screenshot of FIG. 4a, an example of a JA4T method according to the present disclosure is provided below. JA4T will fingerprint the TCP SYN packet sent from the client. JA4TS will fingerprint the TCP SYN ACK response packet sent from the server.

One suitable JA4T fingerprint component format is given as follows:
TCP Options_MSS Value_Window scale
   TCP options are captured in hex in the order they appear. TCP options are limited to 1 byte. A list of common TCP options is provided in the table in FIG. 4b. There are many other TCP options going up to Kind 254, though they are mostly used in specialized environments (think SCADA and Mainframes). The total length of the TCP options list must be evenly divisible by 4. That is the reason why the NOP option exists, to pad out the options list length to a divisible byte count.

The Window Scale acts as a multiplier for the Window Size, allowing the actual Window Size to be much larger than 65535. For example, if the Window Size is 64240 and the Window Scale is set to 8, then the actual Window Size is 64240*2⁸, or 16445440.

The Maximum Segment Size (MSS) is the largest data payload size that the source will accept per packet and is dependent on the overhead in the network connection. For example, the most common Maximum Segment Size (MSS) initially set is 1460, based on an ethernet MTU of 1500. Observing an MSS of 1380 would indicate that there is overhead on the network path, such as a tunnel or VPN, requiring a reduced MSS to account for the overhead. Different network conditions produce different amounts of overhead as shown in the table provided in FIG. 4c. Manually setting an MSS option to be higher than the actual available size will result in poor network performance, latency, and fragmentation.

In the screenshot of FIG. 4a, the options 2,1,3,1,1,4 are available. These would be captured as:
020103010104
   If the TCP options were 2,1,3,28,4, it would be captured as:
0201031c04
   The MSS value is captured in Decimal, not hex. In the above example, the MSS value is:
1460
   The Window scale is captured in Decimal as well. In the above example, the Window scale is:
8
   If any field does not exist, then the output is 00. For example, a packet with the MSS option and no Window scale would be:

$$JA 4 T = 02 \_ 1460 \_ 00$$

Using the above screenshot example, the client-side TCP fingerprint component would be:

$$JA 4 T = 020103010104 \_ 1460 \_ 8$$

Another embodiment of a JA4T component fingerprint is described herein with reference to the diagram of FIG. 4d. JA4T may be logged alongside every session, highlighting unusual network conditions, and to be used as a pivot point in analysis, troubleshooting, threat hunting, and traffic shaping. It is human- and machine-readable, shareable, and can augment threat intel data. While still able to identify the OS/Device, JA4T also helps to identify intermediary proxies, VPNs, load balancers, tunneling, etc. JA4T can be deployed on any network device including netflow sensors, firewalls, WAFs, load balancers, and proxies.

The table shown in FIG. 4e provides a list of several exemplary JA4T component fingerprints. Each operating system has different combinations of window size, options, and window scale. For example, Microsoft Windows does not utilize TCP Option 8 (timestamp), whereas all Unix-based operating systems do. iOS ends with a TCP Option 0 (End of list) whereas other operating systems do not. iOS added another Option 0 to make its options list evenly divisible by 4 rather than removing an NOP (Option 1). This relates back to decisions the programmers made when building the netcode.

Changes in the MSS (part c), can help identify network conditions for the device. For example, each mobile carrier sets a different MSS for the overhead in their cell network as shown in the table of FIG. 4f. This makes it possible to identify the carrier that devices are on as shown in the table provided in FIG. 4g.

When a device is connected through a VPN, the MSS, and occasionally Window Size, are changed based on the overhead of the VPN and encryption ciphers used. When a device is connected through a Proxy, the TCP component fingerprint of the proxy is seen on the server side, not the client. For example, the complete change in fingerprint when an iPhone connects through iCloud Relay is shown in the table provided in FIG. 4h.

### JA4TS: TCP Server Response Fingerprint

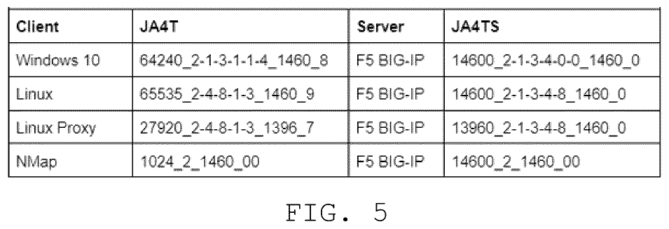

While JA4T is based on the client TCP SYN packet, the JA4TS component fingerprint is based on the SYN-ACK response. TCP servers may respond to different client TCP SYN options differently. This means that any given server may produce multiple JA4TS fingerprints depending on the clients connecting to it. For example, if a client does not include TCP Option 4 (SACK), the server is not likely to include Option 4 in its SYN-ACK response. Thus making JA4TS a TCP Server Response Fingerprint. Examples are shown in the table of FIG. 5. A more accurate fingerprint of the server itself may be provide by an active TCP server component fingerprint as discussed below.

### JA4Tscan: Active TCP Server Fingerprinting

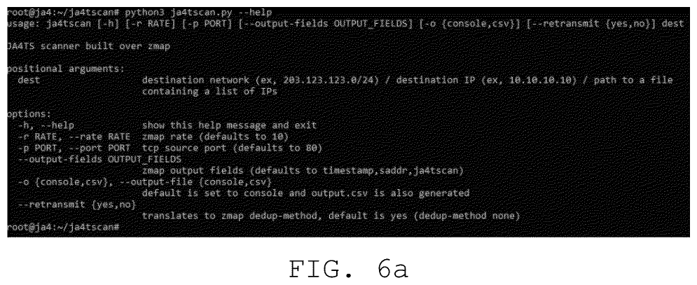

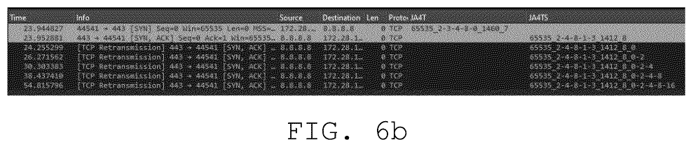

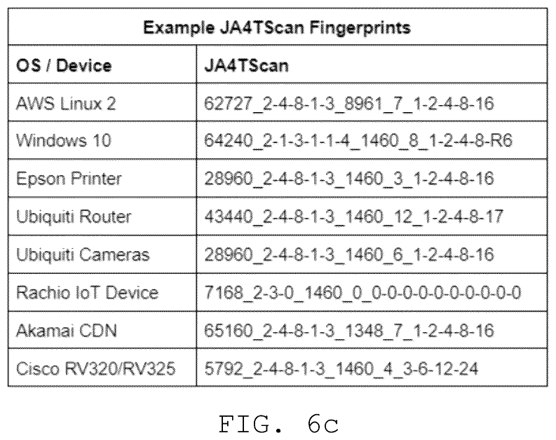

With reference to the screenshot of FIG. 6a, JA4TScan produces a reliable TCP component fingerprint of any server. This is achieved by actively scanning servers with a single SYN packet that includes all common TCP options to produce the most robust TCP SYN-ACK response from the server. It does not respond to the SYN-ACK from the server, but instead listens for retransmissions, counts the delay between each retransmission, and adds those delays to the end of the fingerprint as section e. If an RST packet is observed, it is also added to the fingerprint and prefixed with an “R”. An exemplary scan is shown in the screenshot of FIG. 6b.

TCP retransmissions, the number of retransmissions, and the delay between them are unique per operating system, as they are based on the OS netcode and the decisions of the engineers who wrote it. For example, some IoT devices send several retransmissions less than a second apart to attempt to reconnect as quickly as possible, while other devices will wait one second, retransmit, then wait two seconds, retransmit, then wait four seconds, retransmit, etc. By incorporating the delay between TCP retransmission responses, a robust TCP component fingerprint can be produced using only a single SYN packet. A table of exemplary JATScan component fingerprints is provided in FIG. 6c.

### JA4T Use Case: Internet Scanner Blocker

JA4+ has nearly unlimited use cases. In one such case, JA4+ fingerprints, including JA4T component fingerprints, can be used to combat an important type of cyber threat called edge device compromise. This kind of threat is made possible by threat actors looking for vulnerable edge devices using internet scanning services, e.g., Shodan or Censys, or by scanning themselves. For example, various known threat actors scan the internet multiple times per day, searching for open ports on edge devices. When an open port of interest is located on a particular system, the threat actor knows to send that system exploits (e.g., zero-day exploits) to compromise it. However, it is possible to identify known or suspected threat actors using JA4+ fingerprints and to block the initial scans which prevents the threat actor from knowing that the edge device exists. If the threat actor is unaware that the edge device exists, then it will not send exploits. This provides owners of these edge devices time to patch against significant attacks made possible by, for example, zero-day vulnerabilities.

Using network fingerprints, such as those in JA4+, either on their own or in combination, a “blocklist” of unwanted traffic can be compiled according to a set of rules based on fingerprint characteristics. Such a blocklist can include internet scanning tools. Blocking internet scanner traffic effectively renders a device invisible to those internet scanners, including Shodan, Censys, threat actors, etc. Furthermore, using the JA4+ fingerprints, the device can be configured such that it remains visible on the internet to desirable traffic necessary for normal operations. The rules for blocking this traffic could be implemented, for example, in an on-host firewall utilizing eBPF or in a traditional firewall that includes network fingerprinting/JA4+ support.

Similarly, JA4+ network fingerprints can also be used to compile an “allow list,” such that a system can block all traffic except for traffic from systems with network fingerprints that match the allow list. This would essentially act as an extra layer of authentication as a system could only connect to a particular device if it has an acceptable digital fingerprint, i.e., the fingerprint is on the allow list.

Thus, a traffic blocker using JA4+ fingerprints can be restrictive in which case a device/system is obscured only from traffic with fingerprint characteristics on a blocklist. On the other hand, the traffic blocker can be permissive, in which case the device is only visible to traffic having certain fingerprint characteristics on an allow list. It is also possible for the traffic blocker to incorporate rules that are both restrictive and permissive.

It is possible to implement such a traffic blocker in various devices on a system, for example, on an edge device or as a kernel module on an endpoint device.

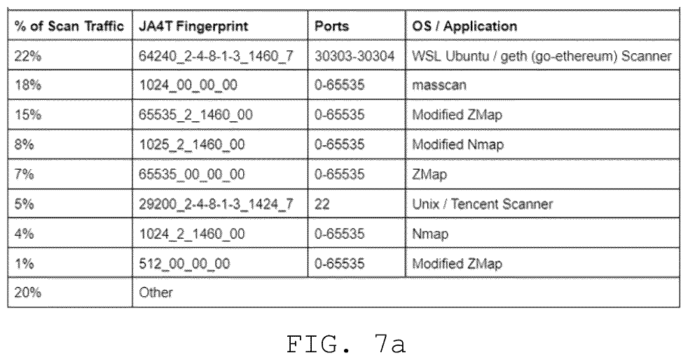

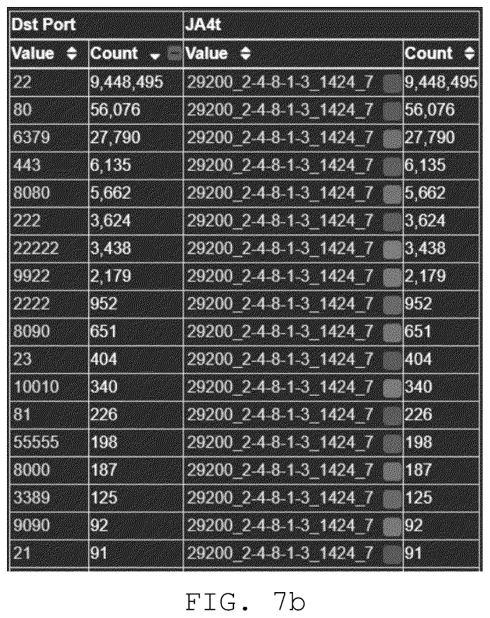

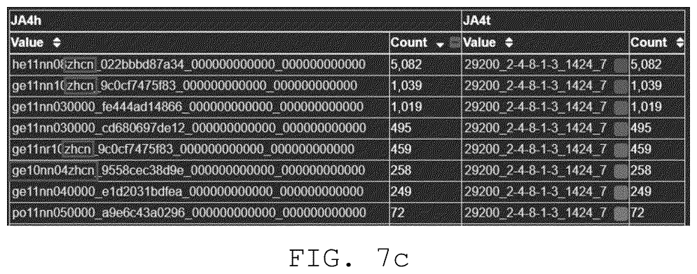

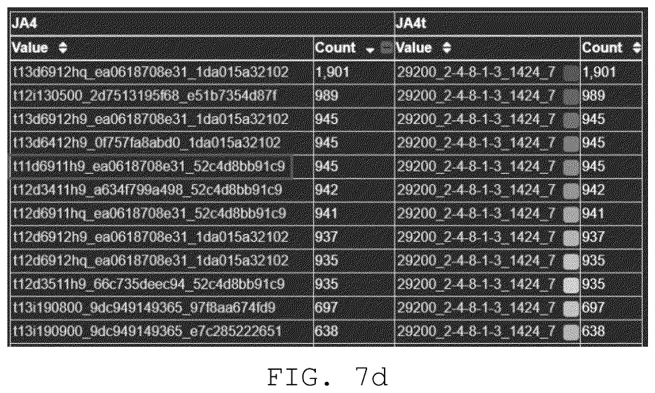

An exemplary implementation of an internet scanner blockers are discussed in more detail below. The table shown in FIG. 7a.

The top JA4T fingerprints and associated destination ports, which make up 80% of all internet scan traffic, appear to be unique and can be blocked using JA4T on a respective WAF, firewall, load balancer, proxy or server. This allows for the heuristic blocking of malicious traffic based on fingerprints rather than constantly-changing IP lists.

When blocking based on JA4T, the block happens at the SYN packet, preventing a SYN-ACK response. This means that the traffic is blocked before the scanner can even tell if the port is up.

With reference to the following JA4T component fingerprint from FIG. 7a: 29200_2-4-8-1-3_1424_7, the following example is discussed. An options list of 2-4-8-1-3 indicates a Unix-based operating system and an MSS of 1424 indicates that these connections have 36 bytes of additional network overhead. This is possibly an unencrypted tunnel or proxy, as 36 bytes is not enough for additional encryption as would be seen in a VPN. Here, hundreds of source IPs with this JA4T fingerprint are observed; however, all are within a particular actor's IP ranges and listening on port 22, with some listening on port 31401. Given the MSS discrepancy, it is possible that these source IPs are not actually the true source of the traffic but instead that traffic is being bounced through them.

Pivoting on the JA4T component fingerprints, it can be shown that this actor's scanning priorities are primarily focused on SSH and alternative SSH ports as shown in the table provided in FIG. 7b. As this JA4T component fingerprint is unusual, it would be safe to block it when the destination port matches 22. However, there is a potential for false positives in production applications over standard ports like 80 and 443. To block these, JA4T component fingerprints can be combined with other JA4+ fingerprints.

The second priority of this particular actor is web server identification. Comparing the top JA4H (HTTP Fingerprint; discussed below) with this JA4T shows that the actor uses a few different bots. Some are simple, while others try to look like a browser with their primary Accept-Language set to “zhcn”, which is Chinese-PRC. In the case of ge10nn04zhcn, the actor is using HTTP 1.0 as an attempt to connect to older devices as shown in the table of FIG. 7c.

Comparing the top JA4C (TLS Fingerprint) with this JA4T reveals that the actor uses a few variations of client hellos when scanning. Its primary scanner is a custom catch-all scanner that supports TLS 1.3, but, also, 69 ciphers. The actor's other scanners support TLS 1.2 and 1.1, indicating that it is looking to connect to both new and old systems with a variety of TLS client hellos. The one JA4C_a of t11d6911h9 is particularly odd because it is TLS 1.1 with an ALPN extension, but ALPN did not exist in the days of TLS 1.1 as shown in the table of FIG. 7d.

Combining this exemplary actor's unusual JA4T component fingerprint with other unusual JA4+ component fingerprints allows for great blocking or detection rules as it is the combination of JA4+ fingerprints that facilitates the creation of detection and blocking rules with minimal false positives.

### JA4H: HTTP Client

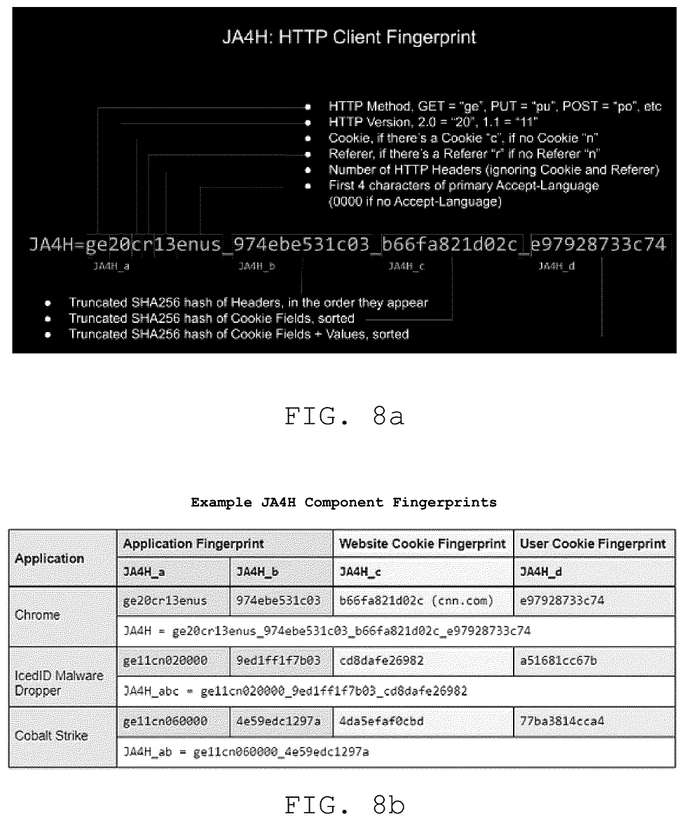

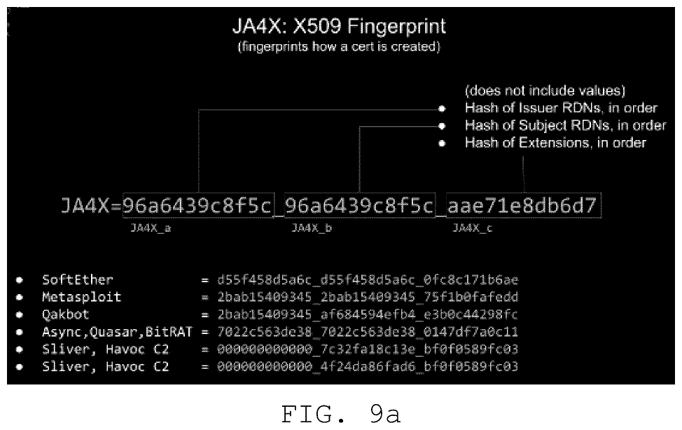

FIG. 8a is a diagram illustrating a method of generating a JA4H component fingerprint according to an embodiment of the present disclosure. JA4H is a component fingerprint of the HTTP Client, provided by methods of the present disclosure.

Each client will have multiple component fingerprints depending how the system is operating. Clients will have different fingerprints when using different HTTP methods and different HTTP versions and will sometimes need to add fields depending on information communicated from the server. However, the fingerprint will generally be the same per client per HTTP method and version, save for cookie details. The last field in JA4H is the cookie component fingerprint. The server tells the client what should go in the cookie; however, the client can do with the cookie as it wishes. This can be useful for detecting browser extensions or malware.

Each session is likely to have multiple JA4H component fingerprints, so each will be logged. One suitable format is as follows:
(2 character http method) (2 character http version) (“c” if cookie exists, “n” if no cookie or new connection) (“r” if referer exists, “n” if no referer or new connection) (2 character number of headers) (4 character first accept-language code)_(12 character truncated sha256 hash of the http header fields, in the order they are seen)_(12 character truncated sha256 hash of the cookie fields, sorted)_(12 character truncated sha256 hash of the cookie fields+values, sorted)

An Examplary JA4H component fingerprint would be:
ge20cr13enus_a82fbf14bc42_457935509480_e97928733c74

### Two-Character HTTP Method Subcomponent:

These are the HTTP methods available and their associated two character code to start the fingerprint:
ge=GET
he=HEAD
op=OPTIONS
tr=TRACE
de=DELETE
pu=PUT
po=POST
pa=PATCH
co=CONNECT

### Two-Character HTTP Version Subcomponent:

The HTTP versions and their associated codes are:

$$10 = HTTP / 1.$$

$$11 = HTTP / 1.1$$

$$20 = HTTP / 2$$

$$30 = HTTP / 3$$

If there is a cookie in the HTTP header, the value is “c” for cookie. If there is not a cookie in the HTTP header, the value is “n” for “no” cookie or “new” connection.

If there is a referer in the HTTP header, the value is “r” for referer. If there is not a referer in the HTTP header, the value is “n” for “no” referer or “new” connection.

### Two-Character Number of Header Fields Subcomponent:

Similarly as above, in one embodiment, the header fields subcomponent may be denoted as follows:
06=6 headers
99=anything>than 100 headers

Then, in the next subcomponent, the first four characters of the primary Accept-Language field are added, ignoring “-” characters). A list of these headers is provided at:
https://www.iana.org/assignments/language-subtag-registry/language-subtag-registry

Some examples of headers in this field are:

Accept-Language: da, en-GB;q=0.8, en;q=0.7
Accept-Language: en-US,en;q=0. 9

The first value prior to the comma is the primary language of the client. JA4H captures this while ignoring the “-” character. The method returns a “0” if less than four characters are used or if no accept-language field exists. Some examples are:
da=da00
en-US=enus
en-UK=enuk
ru-RU=ruru

The headers are captured in a 12-character truncated sha256 hash. The HTTP headers appear after the http version code and start on new lines ending at a “:”. JA4H captures all HTTP header fields, case-sensitive, except for the “Cookie” and “Referer” fields, as those are captured separately, as described above. JA4H does not capture the values. The fields are then concatenated with a “,” delimiter and sha256 hashed using the first 12 characters of the hash. JA4H is not capturing “Cookie” here because it is already captured in the fingerprint above.

The following example is provided for illustrative purposes:

POST /plugins/unassigned.devices/UnassignedDevices.php
HTTP/1.1
Host: 192.168.1.1
Content-Length: 664
Accept: application/json, text/javascript, */ *; q=0.01
X-Requested-With: XMLHttpRequest
User-Agent: Mozilla/5.0 (Windows NT 10.0; Win64; x64)
AppleWebKit/537.36 (KHTML, like Gecko)
Chrome/114.0.5735.110 Safari/537.36
Content-Type: application/x-www-form-urlencoded;
charset=UTF-8
Origin: http://192.168.1.1
Referer: http://192.168.1.1/Main
Accept-Encoding: gzip, deflate
Accept-Language: en-US,en;q=0.9
Cookie: example=d7df2dd0937ec27; ud_reload=UD_reload
Connection: close

The headers captured are:

```
  Host, Content-Length,Accept,X-Requested-With,User-
  Agent,Content-Type,Origin,Accept-Encoding,Accept-
  Language,Connection
The “Cookie” and “Referer” headers are omitted. The sha256 hash
is provided as:
  47d05ed57293244a9b505865f749705e4e7fcbfee3780254b075f4643
  3e51251
The truncated hash is:
  47d05ed57293
```

The next subcomponent is a 12-character truncated sha256 hash of the cookie fields, sorted. The cookie fields are the values before “=” and are delimited by “;”. JA4H captures these fields and concatenates them using a “,” delimiter and then performs a truncated sha256 hash of the string.

An example Cookie is given as:

```
  Cookie: 1P_JAR=2023-06-07-17;
AEC-AUEFqZdaLLwaXJHyxA8-
Cu0i0N4klp_vV3XOuyEYeiWlp4QaeIvSv6t4XKM; OGPC=19027681-1:;
NID=511=rRELE2o91XNLo6eayqEN7Lf2ue7EcSHVkew3oxf4jzyF8vix2BzxTR
vda8MYBFEkLyC1xjTcqSIjbC-
wV2r120jr2HFau_dHvMxUm9fk6W2J2mddt1MpGMA8qGuAZWt1DSpCFFwHZSKBr
yGnvRJUeXkc-jw4sXdWhgCKxeu3f01Na4YsBYGf;
DV=A84BtBIPqhgmIDlq9acmfs7ik-duiZjdmUPDG3eW3QIAAAA
The captured fields are:
  1P_JAR,AEC,OGPC,NID,DV
The fields are then sorted in alphabetical order:
  1P_JAR,AEC,DV,NID,OGPC = 21864220ae3d
```

The next subcomponent is a 12-character truncated sha256 hash of the cookie fields+values, sorted. The cookie fields+values are now captured and sorted similarly as above, using a “,” delimiter and then performing a truncated hash. This part of the fingerprint will be unique to each user but can allow for tracking of individual users through the application without the need to log SPII like username or session tokens.

Using the example above, the cookie is sorted to:

```
  1P_JAR=2023-06-07-17,AEC=AUEFqZdaLLwaXJHyxA8-
  Cu0i0N4klp_vV3XOuyEYeiWlp4QaeIvSv6t4XKM, DV=A84BtBIPqhgmID
  1q9acmfs7ik-
  duiZjdmUPDG3eW3QIAAAA,NID=511=rRELE2091XNLo6eayqEN7Lf2ue7
  EcSHVkew3oxf4jzyF8vix2BzxTRvda 8MYBFEkLyC1xjTcqSIjbC-
  wV2r120jr2HFau_dHvMxUm9fk6W2J2mddtlMpGMA8qGuAZWt1DSpCFFwH
  ZSKBryGnvRJUeXkc-
  jw4sXdWhgCKxeu3f01Na4YsBYGf,OGPC=19027681-1:
Sha256:
  e97928733c7408285e0878640b946867e0a8fd0ac02765ad48a375220
  296a5e3
Truncated:
  e97928733c74
```

The following example of JA4H is provided:

```
  GET /public/api/alerts HTTP/2
  Host: www.cnn.com
  Cookie:
  FastAB=0=6859,1=8174,2=4183,3=3319,4=3917,5=2557,6=4259,7
  =6070,8=0804,9=6453,10=1942,11=4435,12=4143,13=9445,14=69
  57,15=8682,16=1885,17=1825,18=3760,19=0929;  sato=1;
  countryCode=US;  stateCode=VA;
  geoData=purcellville|VA|20132|US|NA|-
  400|broadband|39.160|−77.700|511; usprivacy=1---; umto=1;
  _dd_s=logs=1&id=b5c2d770-eaba-4847-8202-
  390c4552ff9a&created=1686159462724&expire=1686160422726
  Sec-Ch-Ua:
  Sec-Ch-Ua-Mobile: ?0
  User-Agent: Mozilla/5.0 (Windows NT 10.0; Win64; x64)
  AppleWebKit/537.36 (KHTML, like Gecko)
  Chrome/114.0.5735.110 Safari/537.36
  Sec-Ch-Ua-Platform: “ ”
  Accept: */*
  Sec-Fetch-Site: same-origin
  Sec-Fetch-Mode: cors
  Sec-Fetch-Dest: empty
  Referer: https://www.cnn.com/
  Accept-Encoding: gzip, deflate
  Accept-Language: en-US,en;q=0.9
Headers:
  Host,Sec-Ch-Ua,Sec-Ch-Ua-Mobile,User-Agent,Sec-Ch-Ua-
  Platform,Accept,Sec-Fetch-Site,Sec-Fetch-Mode,Sec-Fetch-
  Dest,Accept-Encoding,Accept-Language
Cookie:
  Unsorted:
  FastAB,sato,countryCode,stateCode,geoData,usprivacy,umto,
  _dd_s
  Sorted:
  countryCode,FastAB,geoData,sato,stateCode,umto,usprivacy,
  _dd_s
  ge (HTTP Method)
  20 (HTTP Version)
  c (there is a cookie)
  r (there is a referer)
  13 (13 header fields minus Cookie)
  enus (Accept-Language)
  -
  974ebe531c03 (hash of http header fields)
  -
  b66fa821d02c (hash of sorted cookie fields)
  -
  e97928733c74 (hash of the sorted cookie fields+values)
  JA4H-ge20cr13enus_974ebe531c03_b66fa821d02c_e97928733c74
```

JA4H fingerprints the HTTP client based on each HTTP request. As most traffic is encrypted, JA4H is best utilized on servers, proxies, WAFs, TLS terminating load balancers, and environments where TLS is decrypted. However, JA4H is still valuable even in environments where TLS is not decrypted because many devices and programs, including malware, still communicate over HTTP. The IcedID malware dropper, for example, does not use TLS. These malware programs are very easy to fingerprint.

With reference again to FIG. 8a, JA4H_ab are a component fingerprint of the application for the given HTTP method used. The lack of an Accept-Language is a clear indication that the application is not human-interactive, for example, a bot.

JA4H_c is a component fingerprint of the cookie and will be different for each website visited but will be the same for that website or application. For example, every Plex server or Okta server will produce the same JA4H_c component fingerprint.

JA4H_d is a component fingerprint of the user and will be different per user. This allows for tracking of a user through a website without logging SPII, thereby keeping the logging system GDPR compliant.

FIG. 8b is a table which provides several examples of JA4H component fingerprints.

On the server side, a user could employ JA4H_c as a hunting method, for example. As the server is specifying which cookie fields the client should use, all clients should have the same JA4H_c. Discrepancies would flag further analysis. One could also track a user with JA4H_d and their client application with JA4H_ab or identify bots with just JA4H_ab.

On the client side (proxy, NDR, zero trust), JA4H combined with JA4C and JA4S allow for extremely high fidelity application and malware detection.

It is understood that many other applications are possible, especially when JA4H component fingerprints are combined with other JA4+ component fingerprints as discussed throughout this disclosure.

### JA4X: TLS Certificate Component Fingerprint

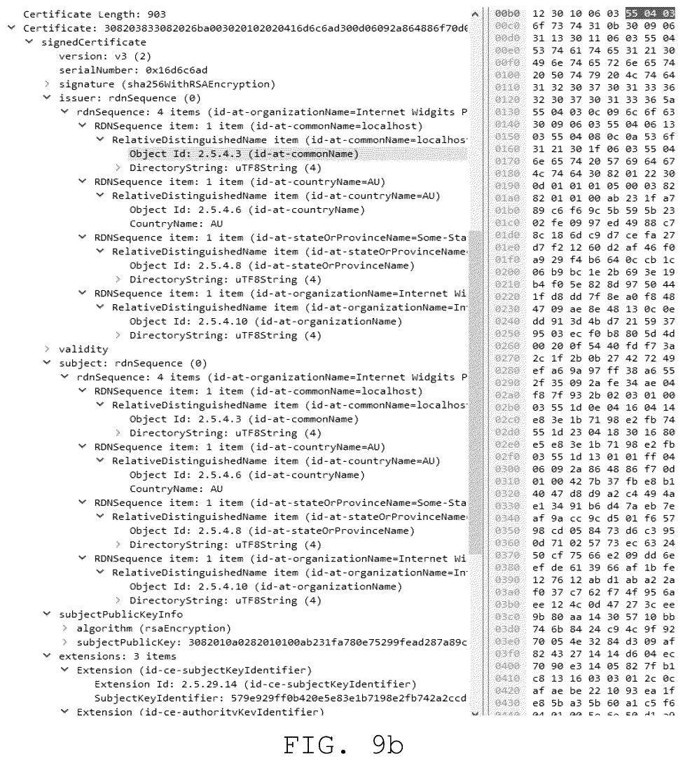

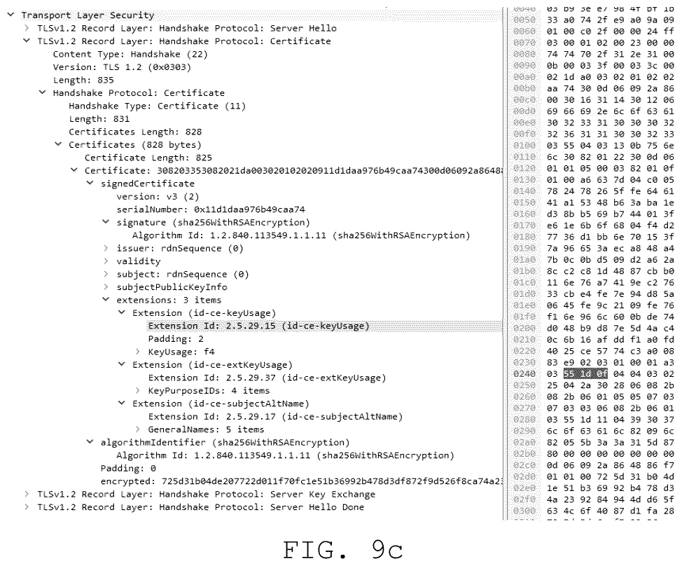

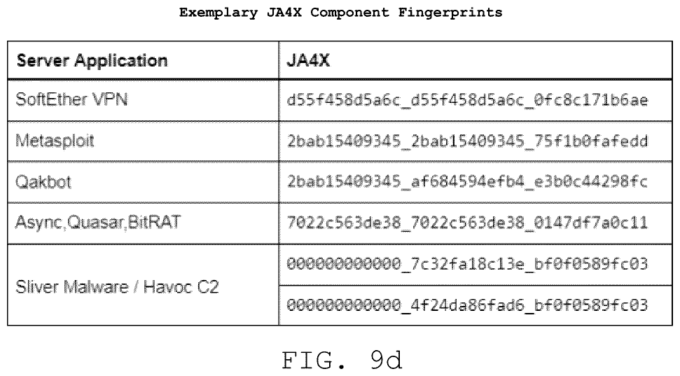

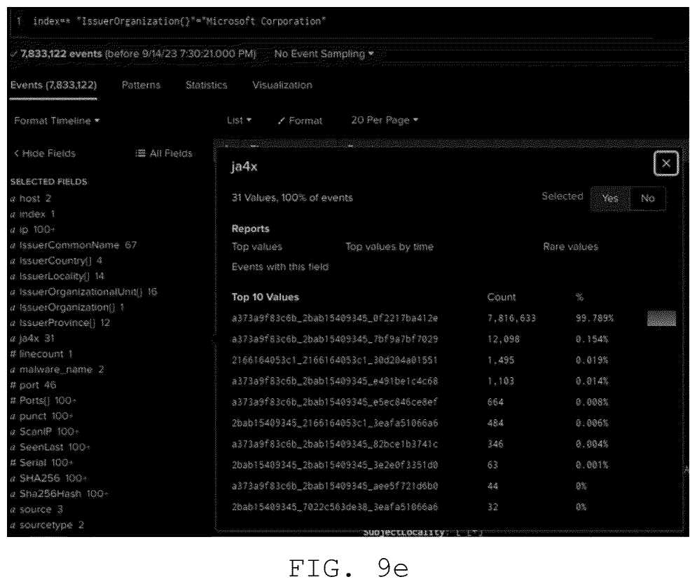

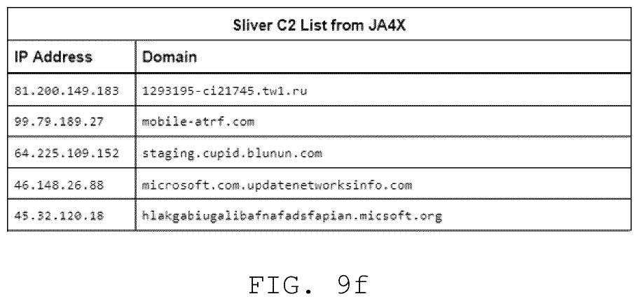

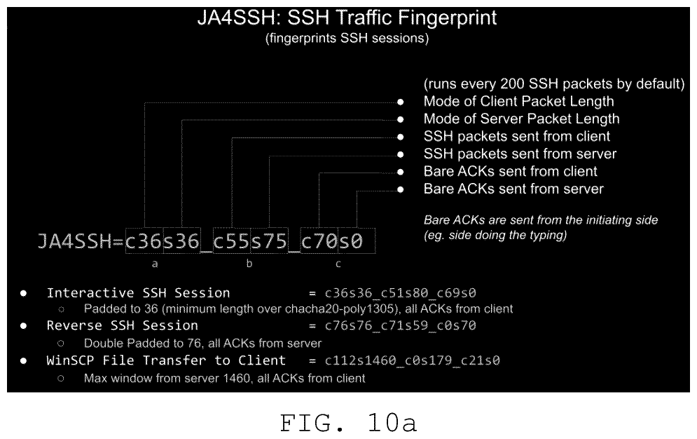

FIG. 9a is a diagram illustrating a method of generating a JA4X component fingerprint according to an embodiment of the present disclosure. JA4X allows for fingerprinting of X509 certificates which enhances detection of infrastructure belonging to particular organizations including detection of infrastructure belonging to threat actors, allowing detection and prevention of network traffic to/from these malicious hosts.

JA4X fingerprints the way in which TLS certificates are generated—not the values within the certificate. This allows for identification of applications and settings used to create the certificate which can be extremely useful in threat hunting as threat actors will create different certificates but tend to use the same methods to create these certificates, thereby resulting in the same JA4X component fingerprint.

JA4X analyzes the TLS certificate (X500/X509/X520). These certificates are encrypted in TLS 1.3 but are sent in clear text in TLS 1.2. This fingerprint should identify the application that was used to generate the certificate. This fingerprint component may be used to scan and identify connections to certain self-signed certificates. It may also serve as a pivot point in hunting.

With reference to the computer screenshots shown in FIGS. 9b and 9c, the format of the fingerprint component is given as follows:

(12 character truncated sha256 of the Issuer RDNs in the
order they are seen)_(12 character truncated sha256 of the
Subject RDNs in the order they are seen)_(12 character
truncated sha256 of the extensions in the order they are
seen)
JA4X = 96a6439c8f5c_96a6439c8f5c _aae71e8db6d7

Only the hex values for the RDNs are used, comma separated, to build out the fingerprint string. In the above example:

Issuer = 550403,550406,550408,55040a = 96a6439c8f5c
Subject = 550403,550406,550408,55040a = 96a6439c8f5c

The hex values are used, so the extensions are:

551d0f,551d25,551d11 = aae71e8db6d7
JA4X = 96a6439c8f5c_6a6439c8f5c _aae71e8db6d7

FIG. 9d is a table that provides several exemplary JA4X component fingerprints. With reference to FIG. 9d, several use case examples are provided herein.

SoftEther VPN was known to be heavily utilized by certain state actors to compromise corporate and government infrastructure and in the hacking of United States government email accounts. According to some experts, it is very difficult to differentiate these connections from legitimate HTTPS traffic. However, because of the programmatic way that SoftEther generates its certificates, the JA4X component fingerprint is unique to SoftEther. If JA4X were to be implemented into a firewall, blocking traffic to SoftEther VPNs would be trivial. And by utilizing a JA4X feed, blocking inbound traffic from SoftEther VPNs would also be easily achieved.

The following example is provided with reference to the screenshot shown in FIG. 9e. Most certificate-issuing organizations will use the same underlying program to generate and sign all of their certificates. Using Internet scan data enriched with JA4X, an exemplary certificate-issuing organization (here, Issuer Organization=“Microsoft Corporation”) is analyzed. The first JA4X component fingerprint in the list of Top 10 Values accounts for about 99.8% of all observed certificates. The second most popular component fingerprint accounts for about 0.15% and looks substantially similar. However, the third component fingerprint value looks entirely different. This may indicate a potential security issue, such as a Cobalt Strike, for example. Hunting with JA4X component fingerprints on Internet scan data is extremely powerful because rather than looking at the values within a certificate, which, in the case of malware, are usually randomly generated, JA4X considers how the certificate was generated.

With reference to the table shown in FIG. 9f, another exemplary use case for JA4X component fingerprinting is disclosed. Sliver C2 is a recently developed pentesting framework. Like other pentesting frameworks, Sliver is also heavily utilized by threat actors as it is designed to be difficult to detect. Sliver has over 400 lines of code dedicated to randomly generating TLS certificates. As such, each certificate is unique and pivoting on a certificate hash will yield no results. However, each certificate is also generated by the same application and therefore has the same JA4X component fingerprint. Havoc C2 uses most of the Sliver code so it too has the same JA4X, but can be differentiated by looking at the Org Name and Postal Code length. In either case, both are malware and the JA4X is unique on the Internet. FIG. 9f includes a list of Sliver C2s that were listening on the Internet that were identified from a JA4X component fingerprint feed.

The examples in FIG. 5f show how JA4X can be used to detect and block traffic to SoftEther, Tor, Metasploit, Sliver, Havoc, RAT C2s, etc. TLS certificates are sent in the clear in TLS 1.2 but are encrypted in TLS 1.3, so JA4X is best utilized on Proxy servers, Firewalls, MDR, NDR and Zero Trust applications that have that level of inspection. JA4X, when combined with JA4C, JA4S, JA4H and/or JA4L, provides a high level of visibility and detection capability. When used in internet scanning, JA4X is an excellent tool for pivot analysis and hunting down malicious servers.

### JA4SSH: SSH Traffic Fingerprint

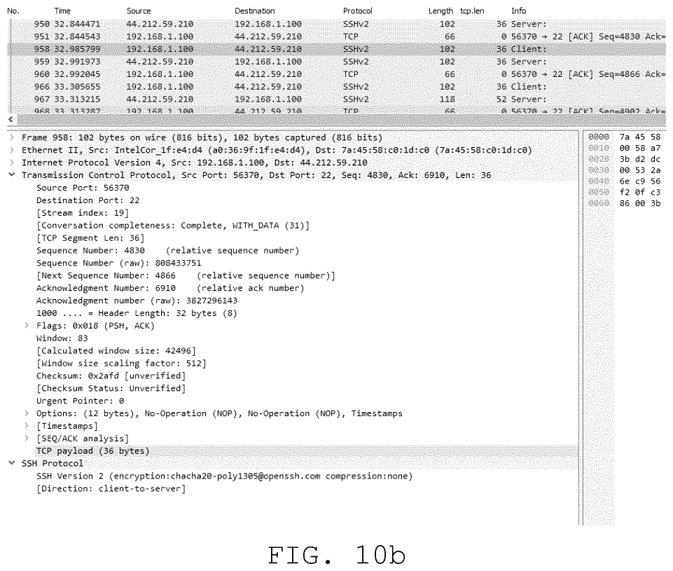

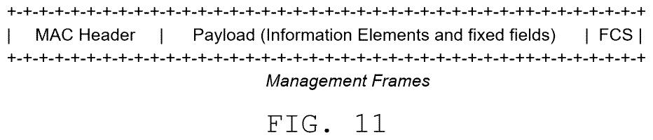

FIG. 10a is a diagram illustrating a method of generating a JA4SSH component fingerprint according to an embodiment of the present disclosure. JA4SSH allows for fingerprinting of SSH communications which can include detection of interactive shells, file transfers, and anomalous SSH activity. It also allows for detection and prevention of malicious activity such as reverse ssh shells.

The method runs every n packets per SSH TCP stream. By default, n=200, but is configurable. So by default JA4SSH is running every 200 packets per SSH TCP stream. This means each SSH stream will have multiple JA4SSH results. The format of the component fingerprint is as follows:

```
  c (mode of client TCP payload length) s (mode of server TCP
  payload length)_c (total ssh packets sent from
  client) s (total ssh packets sent from server)_c(ack packets
  seen from client) s (ack packets seen from server)
Example: JA4SSH = c36s36_c55s75_c70s0
```

With reference to the screenshot of FIG. 10b, one method of measuring the mode for TCP payload lengths across 200 packets in the session is discussed. Here, the method is using the TCP payload lengths, not the packet length. For example, in Wireshark this is under “tcp.len”. This is only for SSH (layer 7) packets. This does not include TCP ACK packets or other layer 4 packets.

The method is looking for the mode, or the value that appears the most number of times in the data set, not the mean or median. For example, if 36 bytes appear 20 times, and 128 bytes appear 10 times, and 200 bytes appear 15 times, the mode is 36. The JA4SSH method calculates this for both the client and server separately.

### Counting the SSH Packets:

The JA4SSH method counts the number of SSH (layer 7) packets sent from the client and server separately. This does not include ACK packets, TCP replays or any other layer 4 packets.

### Counting the ACK Packets:

The JA4SSH method counts the number of TCP ACK packets sent from the client and server separately.

### Example JA4SSH:

```
  c36 (36 bytes was the mode for ssh packet lengths sent from
  client)
  s36 (36 bytes was the mode for ssh packet lengths sent from
  server)
  -
  c55 (55 SSH packets were sent from the client)
  s75 (75 SSH packets were sent from the server)
  -
  c70 (70 ack packets were sent from the client)
  s0 (0 ack packets were sent from the server)
Forward SSH shell (ACKs come from the client) :
  JA4SSH = c36s36_c51s80_c69s0
Reverse SSH shell (ACKs come from the server) :
  JA4SSH = c76s76_c71s59_c0s70
SCP file transfer (always c112s1460) :
  JA4SSH = c112s1460_c0s179_c21s0
```

### JA4W: Wireless Device Fingerprint

This component offers a methodology for fingerprinting 802.11 wireless devices, encompassing both access points (APs) and mobile stations (clients). This passive fingerprinting method leverages the Information Elements (IEs), also known as Tagged Parameters, embedded within IEEE 802.11 management frames. In order to fingerprint the access point devices, the information elements present in the Beacon frames are utilized. Similarly, the same set of information found in the Probe Request frames is employed to fingerprint the mobile/wireless clients.

Management frames, as shown in table of FIG. 11, maintain a uniform structure, remaining invariant irrespective of the frame subtype (the frame subtype is ascertained from the Frame Control field located within the MAC header).

Information Elements (IEs) are variable-length fields characterized by an ID or tag number, a length, and a variable-length data component. IEEE 802.11 mandates a specified order for these information elements. However, some of these elements remain optional and encompass different data contingent on the devices' supported standards, which makes them suitable for fingerprinting.

To compute the fingerprints of wireless devices, the following Information Elements are extracted from both Beacon frames and Probe Request frames:
Ordered list of Information Elements (IEs)
Supported rates
Extended supported rates
HT capabilities
HT AMPDU
Extended capabilities; and
Vendor specific IEs.

It should be noted that other IEs can also be used, including new IEs which may be introduced in the revisions of 802.11. In the prevailing fingerprint configuration, the HT capabilities IE is utilized, which was introduced in 802.11n. Additional IEs, such as the HE capabilities introduced in 802.11ax, could be integrated into the fingerprint to increase its specificity, if necessary.

Prior to applying the cryptographic hash to the JA4W component string to generate the final fingerprint, the decimal values of the extracted information are concatenated. This is done in a specific order, employing a comma (“,”) to separate each field and a dash (“-”) to distinguish each value within each field.

The first field may be an ordered list of information element IDs, for example: 0-1-3-5-7-32-35-42-11-45-61-127-221.

IE fields, except the Vendor Specific IEs, contain the concatenated decimal values or the IE info. An exemplary supported rates IE: 200-96-108.

Vendor specific IEs use the following format:

{Vendor_Specific_OUI}-{Vendor_Specific_OUI_Type}.
{Ordered_Information_Elements}, {Supported_Rates}, {Extended_Sup
ported_Rates}, {HT_Capabilities}, {HT_AMPDU}, {Extended_Capabilit
ies}, {Vendor_Specific_IEs}

### Example

MAC OUI ORG: Aruba, a Hewlett Packard Enterprise Company
Frame Type: beacon
JA4W string: 0-1-3-5-7-32-35-42-11-45-61-127-221-221-221,200-96-108,,44297,23,4-0-8-0-0-0-0-64,20722-2,2950-1,2950-1
JA4W fingerprint component:
e1b658dccdf0f7dfb436bbcbd7a37a52

In some embodiments, the JA4W fingerprint component may be generated in hexadecimal format instead of decimal.

In some embodiments, the fingerprint component may be converted to a JA4+a_b_c format such that it is human readable. In this case, the a portion may include the 802.11 version supported as well as the packet type.

Exemplary use cases of the JA4W fingerprint component include: identifying Rogue Access Points (APs); detecting Evil Twin attacks; recognizing known wireless hacking devices; and countering location spoofing attacks that aim to deceive Wi-Fi positioning systems.

The various exemplary inventive embodiments described herein are intended to be merely illustrative of the principles underlying the inventive concept. It is therefore contemplated that various modifications of the disclosed embodiments will without departing from the inventive spirit and scope be apparent to persons of ordinary skill in the art. They are not intended to limit the various exemplary inventive embodiments to any precise form described. Other variations and inventive embodiments are possible in light of the above teachings, and it is not intended that the inventive scope be limited by this specification, but rather by the claims following herein.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above. Moreover, it is contemplated that combinations of features, elements, and steps from the appended claims may be combined with one another as if the claims had been written in multiple dependent form and depended from all prior claims. Combination of the various devices, components, and steps described above and in the appended claims are within the scope of this disclosure. The foregoing is intended to cover all modifications and alternative constructions falling within the spirit and scope of the invention.

I claim:

1. A method of categorizing computer network communications, comprising:
receiving data related to a communication over a computer network;
extracting information from said communication;
organizing said information into at least one digital component fingerprint, said at least one component fingerprint comprising:
a text string that is delimited into a plurality of sections,
wherein at least one of said sections is human-readable; and
outputting said at least one component fingerprint for analysis.

2. The method of claim 1, further comprising:
comparing said component fingerprint against a database of component fingerprints.

3. The method of claim 1, further comprising:
initiating a security action based on a characteristic of said component fingerprint.

4. The method of claim 1, wherein said component fingerprint is characterized as one from the list comprising:
a Transport Layer Security (TLS) server response/session fingerprint;
a Hypertext Transfer Protocol (HTTP) client fingerprint;
a latency measurement distance/location fingerprint;
a passive Transmission Control Protocol (TCP) client fingerprint;
a passive TCP server response fingerprint;
a Secure Shell Protocol (SSH) traffic fingerprint; and
an active TCP server fingerprint.

5. The method of claim 1, further comprising:
combining a plurality of component fingerprints related to said communication to create a composite fingerprint.

6. The method of claim 1, wherein said at least one component fingerprint is a latency measurement distance/location fingerprint, said method further comprising:
using a plurality of said component fingerprints to determine the physical location of a client or a server.

7. The method of claim 1, further comprising:
analyzing said at least one component fingerprint to determine whether said communication is from a virtual private network (VPN) or a proxy server.

8. The method of claim 1, further comprising:
based on said at least one component fingerprint, initiating a security action to obscure a device/system from an internet scanner.

9. The method of claim 8, wherein said device/system remains visible to other devices/systems having a certain characteristic.

10. A computer-readable medium storing instructions that, when executed by a computer, cause said computer to perform the following steps:
receiving data related to a communication over a computer network;
extracting information from said communication;
organizing said information into at least one digital component fingerprint, said at least one component fingerprint comprising:
a text string that is delimited into a plurality of sections,
wherein at least one of said sections is human-readable; and
outputting said at least one component fingerprint for analysis.

11. A computer system, comprising:
a communicative connection to a network;
a memory for receiving data related to a communication over said network; and
a processor for extracting information from said communication and organizing said information into at least one digital component fingerprint, said at least one component fingerprint comprising:
a text string that is delimited into a plurality of sections,
wherein at least one of said sections is human-readable.
